(19) United States
(12) Patent Application Publication
(10) Pub. No.: US 2017/0358173 A1
(43) Pub. Date: Dec. 14, 2017

(54) METHOD AND APPARATUS FOR NETWORKED SOCIAL BETTING

(71) Applicant: MOBI-HOLDINGS INC., Los Gatos, CA (US)

(72) Inventor: Douglas Robert MCCAFFERTY, Los Gatos, CA (US)

(73) Assignee: MOBI-HOLDINGS INC., Los Gatos, CA (US)

(21) Appl. No.: 15/524,382

(22) PCT Filed: Nov. 4, 2015
(86) PCT No.: PCT/US15/59013

§ 371 Date: May 4, 2017

Related U.S. Application Data
(60) Provisional application No. 62/075,457, filed on Nov. 5, 2014.

(51) Int. Cl. G07F 17/32

(52) U.S. Cl. CPC G07F 17/3244; G07F 17/3239; G07F 17/323; G07F 17/3288; G07F 17/3269; G07F 17/3218; G07F 17/3272; G07F 17/3262

(57) ABSTRACT

Embodiment's of a method and apparatus for networked social, belting include a self-arbitrating belting subsystem that facilitates betting among users of the system. Users determine all aspects of a proposed bet, including subject mailer, terms, conditions, and participants. The system tracks and stores bet information, both current and historical The system communicates with one or more financial institutions to facilitate payments from one user to another in settlement of bets, but does not provide banking services or participate in bets. Aspects of the method and apparatus include storing friends lists from which users can choose other to invite to bet. Users can also post bets on many social media platforms to let others (even non-users) know about the status of bets, or to invite others to bet. Aspects further include a method for maintaining a reputation measure for users that is based on whether users tail to resolve disputed bets, or act in any other undesirable manner.

This application claims priority from U.S. Provisional Application No. 62/075,457, filed Nov. 5, 2014 which is incorporated by reference in its entirety herein.

### FIELD OF INVENTION

Embodiments of the present invention are directed to social gaming. More particularly the present invention is in the field of social betting between people known to each other.

### BACKGROUND

Current gaming and/or betting methods typically involve the user placing bets with an entity that acts as the “gaming house”. This is true whether or not the user is betting against other users, and regardless of what the subject of the bet is. The gaming house performs various functions including setting odds, arbitrating, declaring winners, collecting funds, and providing payouts.

It would be desirable for individuals known to each other to engage in social betting on any topics chosen by the bettors, in a system that allows the bettors themselves to declare outcomes, dispute outcomes, and arbitrate disputed outcomes without an entity acting as “house”. In addition, it would be desirable for bettors known to each other in such a system to have a reliable system and method for settling bets without an entity acting as “house”.

### BRIEF DESCRIPTION OF THE DRAWINGS

FIG. 1A is a block diagram of betting system, according to an embodiment.

FIG. 1B is a block diagram of aspects of the betting system, according to an embodiment.

FIG. 2 is a flow diagram illustrating a betting method, including an indication of user interface information, according to an embodiment.

FIG. 3 is a flow diagram illustrating six betting states of the betting method, including an indication of user interface information with fund management and arbitration, according to an embodiment.

FIG. 4 is a flow diagram illustrating a betting system flow using hash tag bets, according to an embodiment.

FIG. 5 is a flow diagram illustrating a betting system flow using voice bets, according to an embodiment.

FIG. 6 is a flow diagram illustrating an onboarding process for a new user, according to an embodiment.

FIG. 7-FIG. 23 are screen shots of a self-arbitrating betting system UI according to an embodiment.

FIG. 24A is a flow diagram of a counter bet feature of the betting system according to an embodiment.

FIG. 24B is a flow diagram of a disputed bet process according to an embodiment.

FIG. 25 shows a device screenshot of the betting wheel UI according to an embodiment.

### DETAILED DESCRIPTION

The present invention includes a system and method that allow two or more parties to bet on any topic or event and facilitate the entire transaction, including arbitration, without a relationship with a gaming house or third path to set odds, declare winner, collect funds, arbitrate or provide a payout. This allows the bets to fall into the category of games of skill, as opposed to chance, because bets can be won by successfully utilizing knowledge the players have regarding each their respective personalities and playing styles, and is established advance of the start of the game.

Embodiments of the present invention include a method and system for providing betting information (for example, betting on sports events, but embodiments are not so limited), in real time, and utilizing a standard Internet connection on any Internet-capable device to facilitate the betting activity.

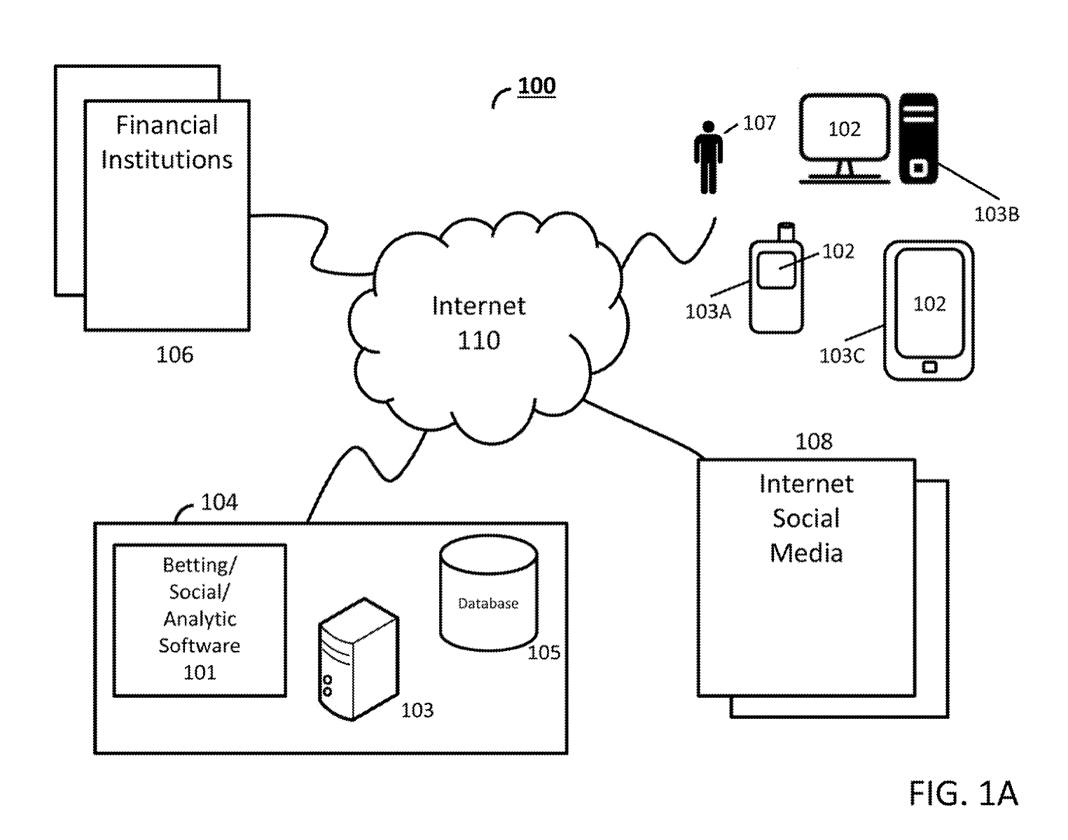

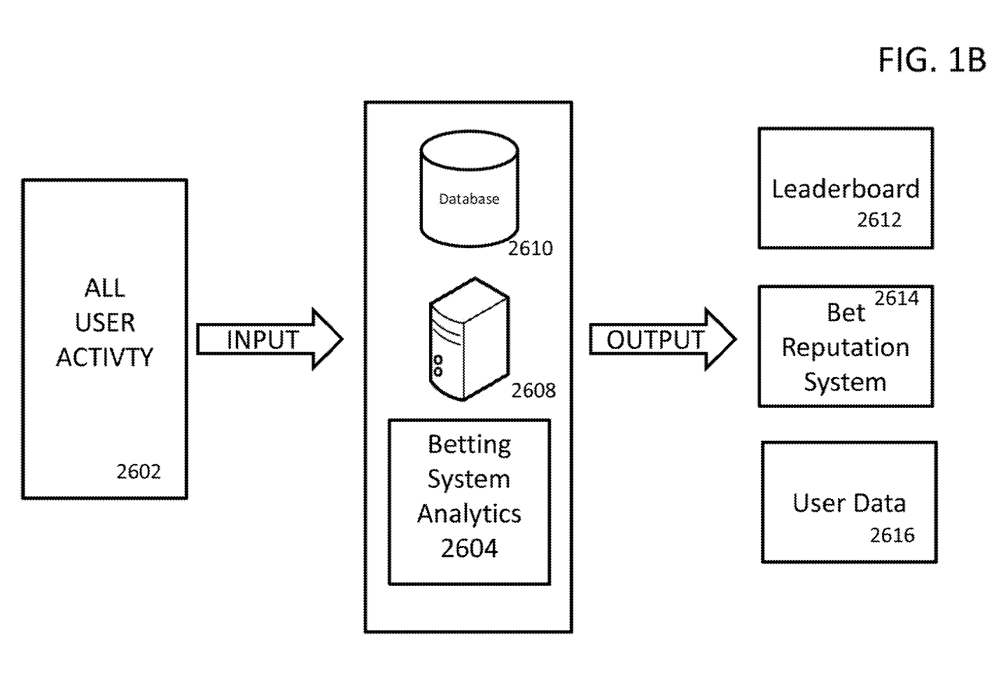

FIG. 1A is a block diagram of a betting system 100 according to an embodiment. System 104 includes a sells-arbitrating betting subsystem 104 that includes multiple servers/processors 103, and databases 105. Subsystem 104 further includes software 101, which executes on servers/processors 103 to perform self-arbitrating betting method as described herein, including but not limited to betting, sharing betting aspects using social networking, analytic functions regarding betting, and more. Any of the elements of self-arbitrating subsystem 104 can, and typically are distributed geographically. For instance, the execution of software 101 can be distributed anywhere, as cm be the storage of the software 101 itself, or any of the databases 105.

Subsystem 104 communicates through Internet 110 with multiple users 107. Users 107 participate in the betting methods described through a user interface 102. User interface 102 is served and administered from subsystem 104, and can be accessed from any appropriately capable device 103, such as smart phone 103A, personal computer (PC) 103B, tablet computer 103C, and so on.

As an aspect of the betting system, a user can broadcast bet offers, accept bet offers, or share aspects of the bet using social media 108. Examples of social media include Facebook™, Twitter™, MySpace™, SnapChat™, Instagram™, and others.

User funds are stored in one or more of financial institutions 106. In an embodiment, the betting subsystem 104 maintains one or more accounts on behalf of the users and tracks deposits and payments based on bets made, won, and lost.

FIG. 1B is a block diagram of illustrating inputs and outputs of the self-arbitrating betting system 104 according to an embodiment. The betting system tracks all user activity 120, including but not limited to, how many times a user generates a bet, accepts a bet, declines a bet, wins a bet, loses a bet, draws a bet, disputes a bet, counter offers a bet, how many friends they have in the betting system, how many friends they have invited to the betting system, which social networking or device contacts are synced to the betting system, and how much money they have won or lost. This user activity 120 is actively being collected by the betting system servers 103 and stored in the betting system databases 105 at all times. The user activity 120 is processed by the betting system analytics 101 to produce data sets or algorithmic outcomes that form outputs. In an embodiment, one output is the betting system leaderboard 122. The betting system leaderboard 122 is a set of data that is available to any user of the betting system 104. The leaderboard 122 allows a user to sort and track past betting data and compare it with all users of the betting system. The leaderboard 122 allows a user to know how many times they have won, lost or drawn over a given period of time. The user can also compare their data against another user's data. Another output of the betting system 104 is the betting reputation system 124. The betting reputation system 124 assigns a reputation measure (a “rating”) to players based on their betting history. A player's rating, according to an embodiment, determines whether users can participate in a bet and what amounts they can bet. For example, the betting system can be designed to limit a new user from betting more than one hundred dollars ($100.00) on any of their first five bets. Or alternatively, as an example, the betting system limits how much money a user can deposit based on how many bets they have completed. Another output of the betting system 104 is user data 126. User data 126 includes, but is not limited to, the user's name, age, address, banking institution, how much they bet over given periods of time, what times they make bets, what bet topics they generate, what bet topics they accept and who their friends are. In an embodiment, the user data is stored for marketing purposes or sold to another organization for marketing purposes.

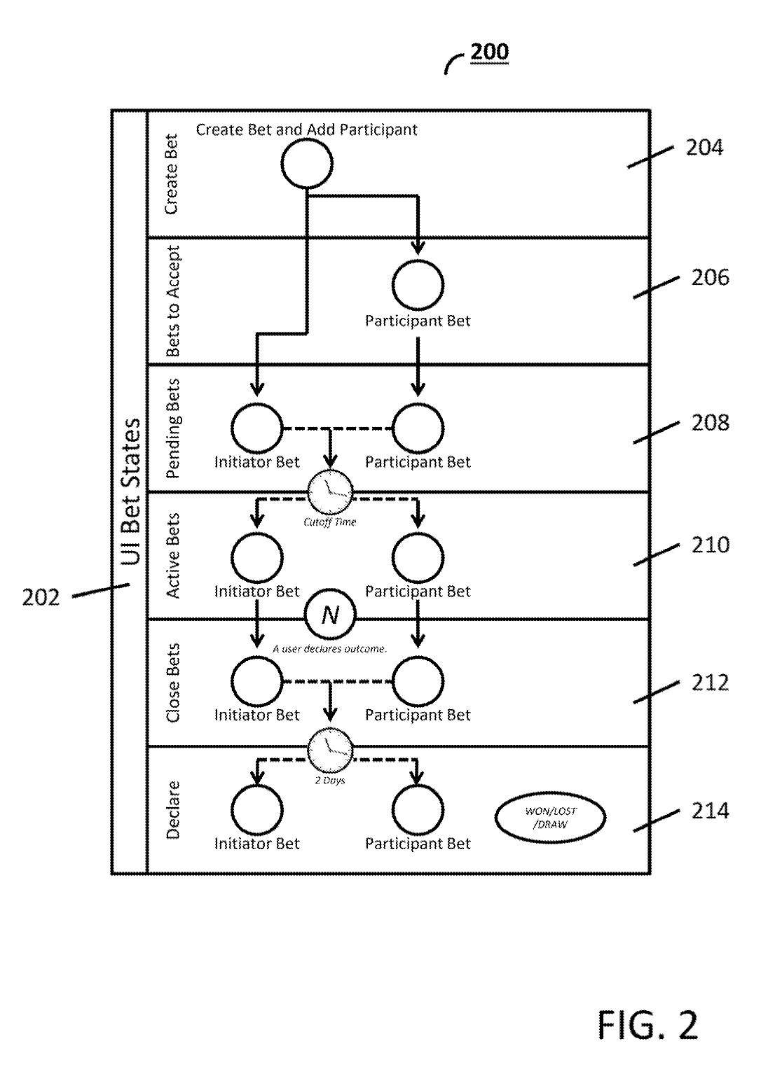

Referring to FIG. 2 a flow diagram of a betting process 200 according to an embodiment illustrates six bet states. A user sees different user interface (UI) 102 screens for each state. This is one example of a betting process, by giving an example of one bet that is managed by the subsystem 104 through bet initiation, sending the bet, accepting the bet, rejecting (possibly) the bet, reminding user of the bet (e.g. reminding to accept or declare the bet), declaring the bet and disputing a bet declaration. The last phase of the betting process 200 is the release of funds.

State 204 “Create bet” allows a bet initiator user (INT) to generate a bet on any event or topic and then send that bet to an individual or group. The INT has the option to set a time when the bet will expire; a time by which the bet must be accepted (date and time). Other users who are invited to participate (referred to as participants, or PARs) receive a notification informing them there is a bet waiting for them. In this embodiment, the notification regarding the bet offer will be sent using the betting system's push notification service. The notification can also be by any known electronic messaging method, including but not limited to SMS, text, voice mail, email, social media, etc. The INT selects a currency and bet amount. The bet amount is then drawn from the INT's available funds in a prefunded user account administered by the subsystem 104.

State 206 “Bets to accept” holds betting invitations that have neither been accepted nor rejected by those who were invited to participate in the bet but still have a cutoff date and time which has not yet been reached. In some embodiments, particular rules apply to state 206. For example, in an embodiment, the INT cannot be involved in this state. Additionally, once a bet is created, all PARs can see who the bet invite has been send to. Furthermore, once PARs accept the bet, they are moved to Pending bet state 208. If a PAR does not accept a bet offer prior to a predetermined cutoff time, that PAR is removed from the process automatically and is not able to view any status or outcome for that bet.

State 208 “Pending bets” holds bets where no action is required either from the INT or the PAR(s), this state is then waiting for a cutoff date to pass. The bet can have all PARs respond (accept or reject) or can have a subset of PARs respond. Those that do not respond will not be able to follow the bet to completion. In some embodiments, particular rules apply to state 208. For example, in an embodiment, there is a waiting period for both the INT and the PAR, and no action is allowed during the waiting period. The bet stays “pending” even though it has been accepted. When the time frame set by the INT to accept the bet has expired, the bet moves to the next (Active bet) state.

State 210 “Active bets” contains all the accepted bets in which a cutoff date has passed but no one has declared results or an outcome. Any of the PARs or INTs can declare the result, and when a declaration has been made the bet will move to the closed state. In an embodiment, the declaration is made by the INT. A declaration states the outcome of the bet: e.g. either the INT won, or the INT lost and the PAR(s) won. If PAR(s) contests the declaration, a disagreement can be entered by the contesting PAR(s). The disagreement includes the contesting PAR's alternative statement of the outcome, and any supporting proof in the form of photo, video, or other electronic data. If the INT agrees with the PAR's alternative statement of the outcome, the result is changed to the alternative statement. If the INT does not agree with the PAR's alternative outcome, the result is changed to a draw. As further described below, if a particular PAR generates a large amount of draws (“large amount” can be variously defined in different embodiments) as a result of multiple alternative statements of outcome the rating of PAR will be negatively affected. In some embodiments, particular rules apply to state 210. For example, in an embodiment, there are certain cutoff times. An example is a predetermined waiting period set by the INT prevents results being declared before the expiration of the waiting period.

State 212 “Close bet” holds the bet for a period determined by the users after the first result is declared and allows for arbitration (referred to herein as the arbitration period). Any PAR or the INT may disagree with the declared outcome. If any PAR in the wager/bet does not agree with the outcome, the bet will then be considered a draw. In some embodiments, particular rules apply to state 212. For example, in an embodiment, there is time within which a PAR can contest a declaration made by the INT. If a PAR disagrees with an outcome the INT has a limited time within which to respond to the disagreement. If the INT does not respond within the set time, the bet outcome is a draw.

State 214 “Declare” holds expired bets labeled as one of three different outcomes: WON; LOST; or DRAW. Any of the users (PARs or INTs) can search past bets by date, person or outcome. In an embodiment, the “Declare” state outcomes for past bets can be viewed in the archive list in the user notifications list.

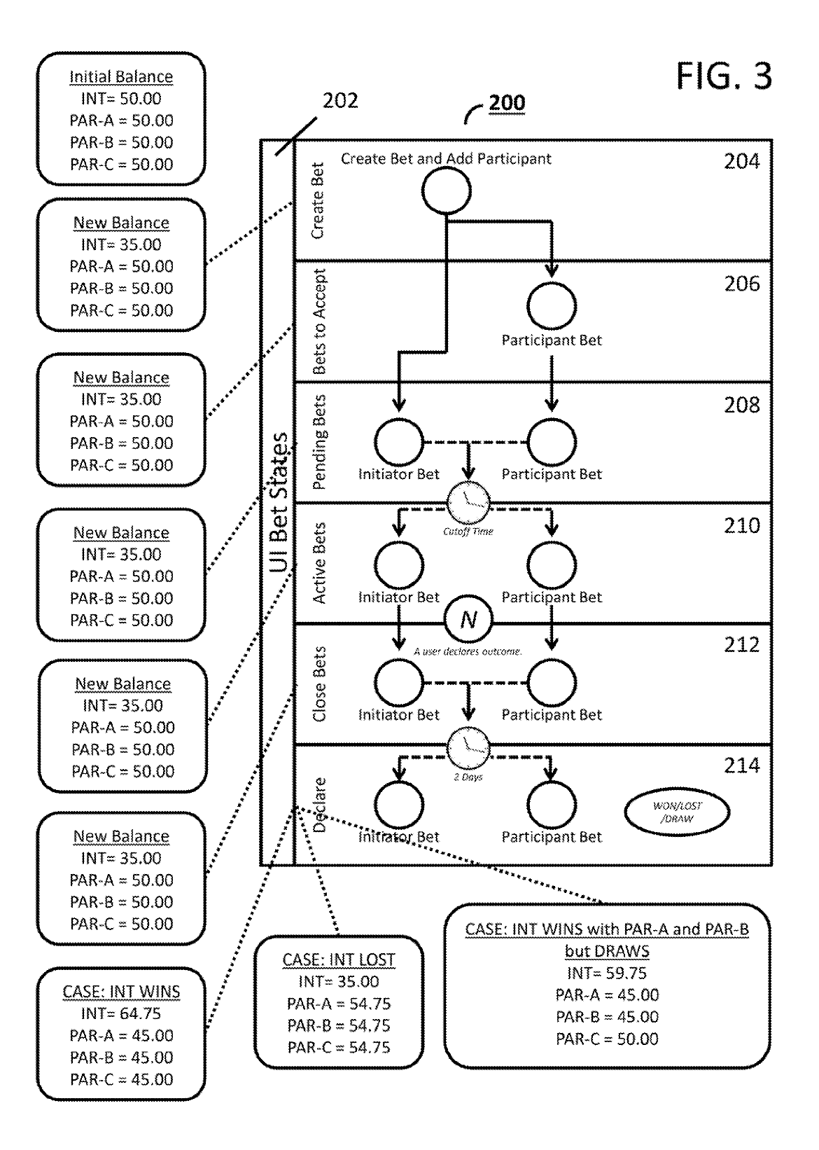

Referring now to FIG. 3, a flow diagram showing further detail of the process described with reference to FIG. 2. As further described below, users can add funds or points to their accounts, and then transfer, donate, and withdraw funds. Furthermore, according to an embodiment, user intimation is stored on a secure server rather than locally on the device.

The server can communicate not only with banks, but with other payment providers such as PayPal™ to validate a user's credentials or transfer funds in and out. All funds in a user account to be moved in or out require a second authorization in the form of pin or password. This security feature provides security in that no user data is stored on the user device should the user device be lost or stolen.

FIG. 3 shows that there are four users: one initiator (INT); and three participants (PAR A, PAR B, and PAR C), each of whom have transferred funds into respective accounts using the betting system through UI 102.

In state 204, the INT creates a bet and funds are taken from his account to cover all losses and any transaction fees. The INT then selects all participants to whom he has sent a request to participate in the bet or wager. If the INT does not have enough funds they will be asked to add funds before continuing.

State 206 holds bet invitations that have neither been accepted nor rejected by those whom the INT asked to participate. If the PAR accepts the bet/wager before the cutoff date, funds and transaction fees are taken from each PAR account and held. In the example of FIG. 3 the three PARS have now accepted the bet or wager, and funds have been taken from each of their accounts (including a transaction fee) and held in escrow. Once the bet is accepted by each PAR, each PAR will have the opportunity to review the bet and any fees prior to accepting the pending bet.

State 208 hold bets when no action is required either from INT or PAR. Once the bet cutoff or accept time has passed the bets automatically move to Active Bets (state 210), and any funds from INT and PARs are in escrow and held until the bet has completed and winner(s) declared.

State 210 contains all the bets that are accepted and in which a cutoff date has passed, but no one has declared results or outcome. Once the cutoff or accept time has passed any party associated with the bet may declare a winner. No funds are moved or awarded in this state. The bet is moved to state 212 (Close bets) once any INT or PAR declares a winner. Funds are still in escrow and will not be dispersed until each party agrees with results, or the time to accept or contest the result has passed.

State 212 holds the bet for a pre-determined period after first result is declared and allows for arbitration. Any user (INT or PAR) may disagree with the declared outcome. If any PAR in the bet does not agree with the outcome, the bet will then be considered a draw. If the arbitration period has passed, and no user objects to the outcome, then funds will be transferred to the winner's bank account (or to another recipient designated by the user, such as a charity). If there is a disagreement regarding the outcome, the bet is considered a draw, and the funds bet by each party (INT & PAR) are returned to respective accounts less any transaction fees.

In the example of FIG. 3 there are three outcomes: INT wins, INT loses, PAR wins, or a draw between the TNT and any of the PAR.

State 214 holds expired bets in three different outcomes: WON; LOST; and DRAW. The INT can have more than one outcome on the same bet due to the fact one of the participants did not agree with the outcome (for example a DRAW and a WIN, or a DRAW and a LOST). This means that in some bets the INT will win with some of the PARs, but may have a draw with all or a subset of the PARs.

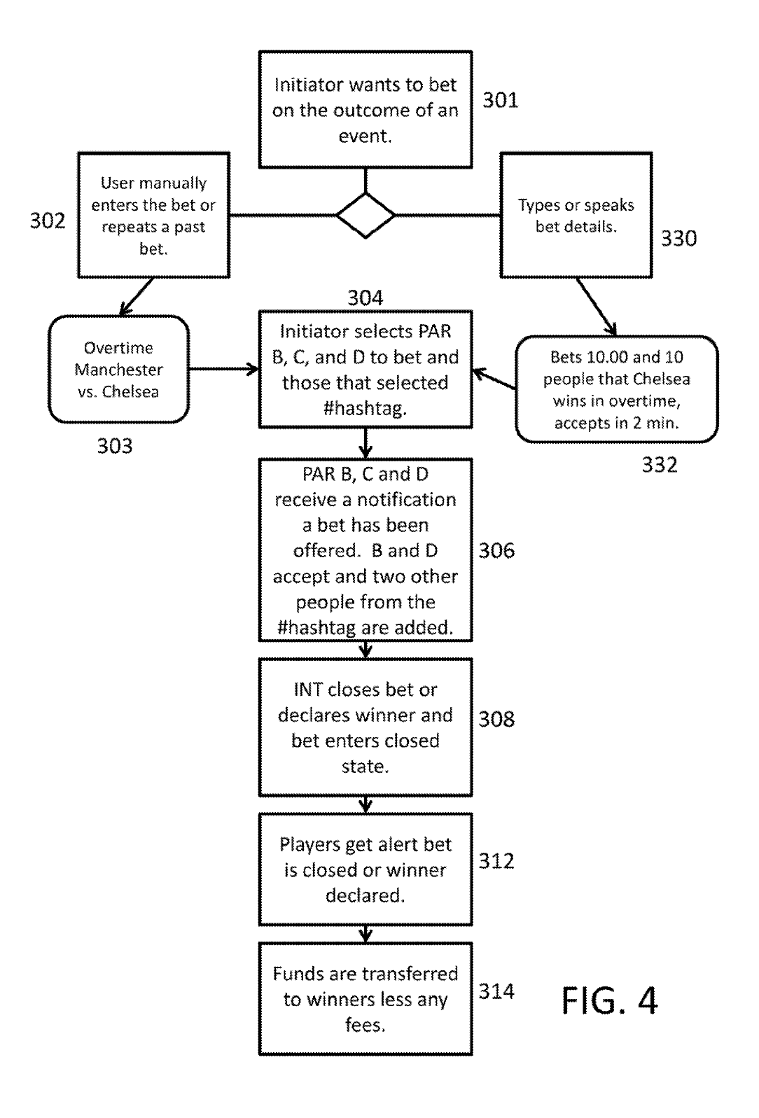

FIG. 4 is a flow diagram illustrating the betting system flow using hashtag bets. A hashtag is a type of label or metadata tag commonly used in social network and microblogging services. Hashtags make it easier for users to find messages with a specific theme or content. Users create and use hashtags by placing the hash character (“#”) in front of a word or phrase, either in the main text of a message or at the end. Searching for that hashtag will then present each message that has been tagged with it. In an embodiment, the betting has a common message feed where users can post text, photos or videos tagged with a hashtag. Furthermore, in an embodiment, an INT can predetermine how many bets to automatically accept from the hashtag that is broadcast to the betting system message feed. The INT can also add limitations to what PARs can accept the hashtag bet. The INT can set the Hashtag bet to only accept bets from PARs with certain reputation ratings. The INT may also select to review each PAR who accepts the hashtag bet offer. In an embodiment, PARs can search for hashtag bet offers in the betting system based on topic or key word as opposed to just watching the betting system message feed for hashtag bets to appear that interest them. Additional to the search feature is an auto-notification system where a user can be notified every time a hashtag bet regarding a specific bet topic is created.

The betting system flow starts with the initiator INT wanting to bet on the outcome of an event 301. The bet can be initiated by the INT manually by entering the details of the bet or by using a “past bets” pulldown to repeat a bet with a former PAR (302). In this embodiment the INT creates a bet on the outcome of a soccer game, such as will the game go into overtime (303). For this bet, the INT then selects players to bet from INT contacts and adds those that selected the hashtag made for this bet (304). A notification through the push notification service is sent to the selected PARs from the contacts and the hashtags (306). For the PARs that accept the bet the bet status is changed from pending to accepted in their notification list, and a notification is sent to the INT and PARs indicating that the bet has been accepted. Funds are taken from the accounts of the INT and PARs (308). During this bet creation the INT can provide a time by which the bet offered is closed to new PARs, or if no time is provided the INT can close the bet to new PARs at any time (320). Once the outcome of the event occurs, the INT declares the winner and closes the bet (310). After the bet outcome is declared by INT, the PARs receive a notification that the winner for this bet is declared (312). Funds are then transferred to the winner of the bet less any fees for the bet (314).

Another way the bet can be initiated by the INT is by voice. By speaking the bet details and desired PARs to their device 103 (as shown at 330), the INT causes the betting system to recognize the bet parameters and generate a bet (332). From there on the process is the same as for bets initiated manually (302).

Another way the bet can be initiated by the INT is to use a “bump bet” feature. The bump bet feature allows an INT and PAR in the same area to tap their devices 103 to accept a bet (322). From there on the process is the same as for bets initiated manually (302).

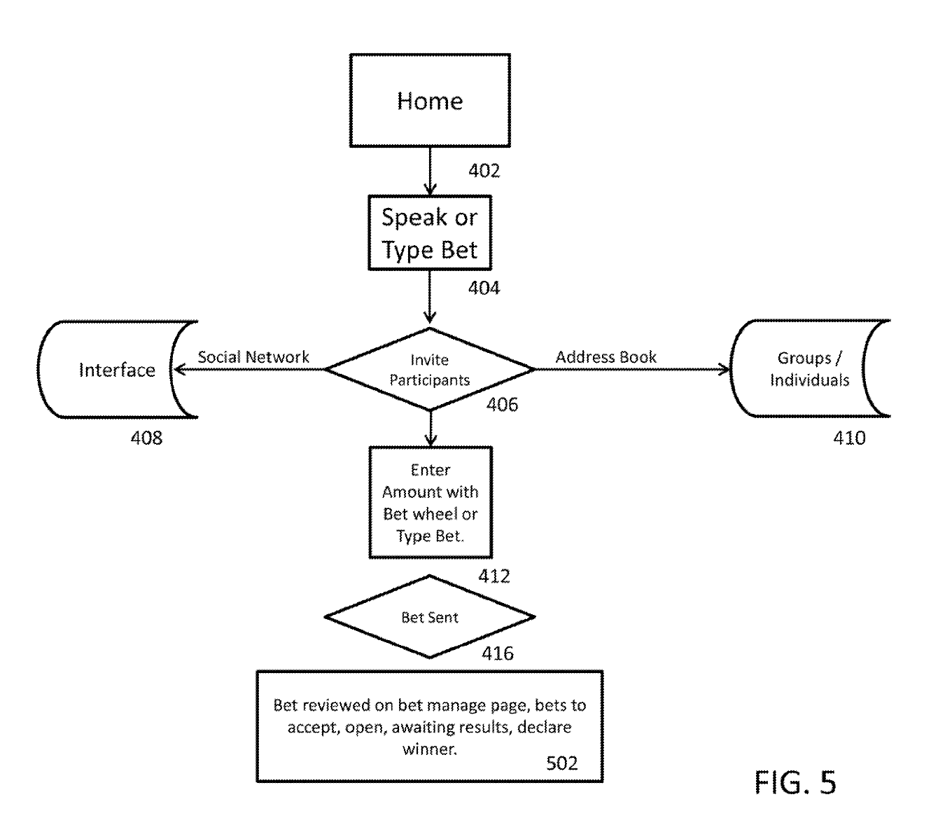

FIG. 5 is a flow diagram illustrating the betting system flow using voice bets. The INT generates the bet (402) by going to the home screen of the betting system UI 102. The INT then selects the voice bet feature and is prompted to speak bet details into the device (404). The INT then speaks the PARs names he would like to invite to the bet (406). The PARs may come from either an address book 410 contained in the betting system or from an associated social networking address book 408, but embodiments are not so limited. The INT can then edit the PARs invited to the bet by typing additional entries or removing undesired ones (406). The INT can also edit manually the details of the bet. The details of the bet can be entered manually, or alternatively, the UI 102 includes visual representations of bet parameters that can be selected by the INT (412).

Once the details of the bet are confirmed by the INT, the bet is sent to the selected PARs for their approval (416). The bet of is reviewed on a bet management page of the UI 102 where bets are displayed as open, pending results, or waiting for a declaration (418).

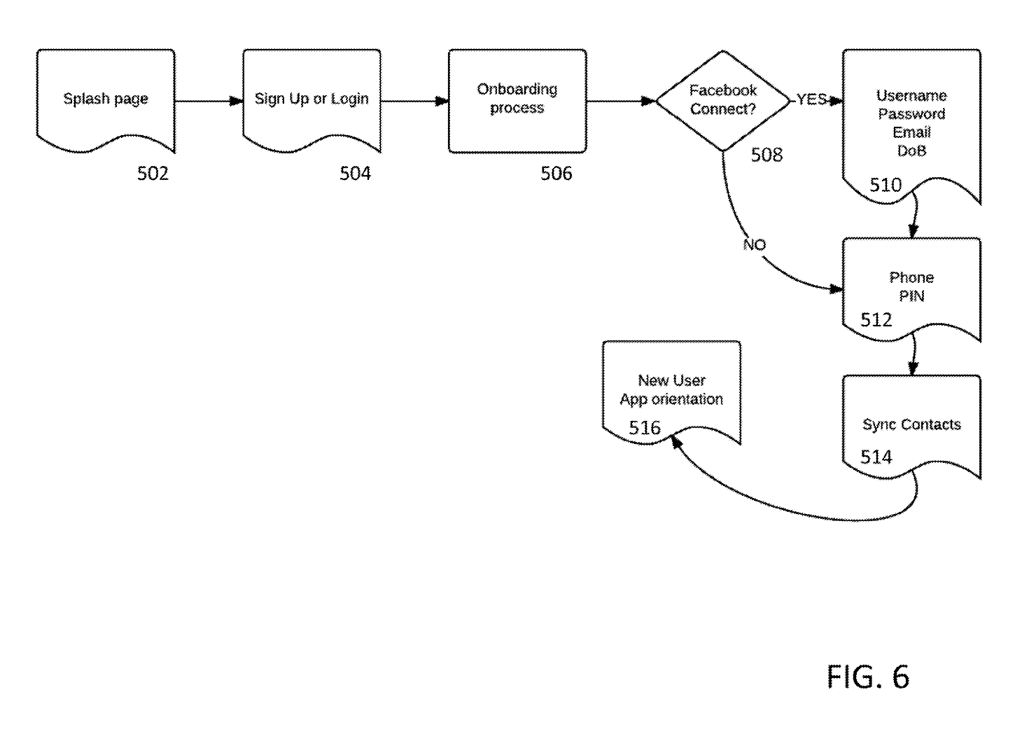

FIG. 6 is a flow diagram illustrating an onboarding process for a user new to the betting system. The new user initially sees a splash page (502). The user then selects to sign up or login (504). The user then enters an onboarding process (506). As part of the onboarding process, the user is offered to connect their betting system account to a social network (508). If the user desires to connect their account to a social network they are asked to enter their social network username, password, email and date of birth (510). The user is then asked to enter a PIN or password for the device to approve the synchronization of the contacts stored on the device with the betting system application (512). If the correct PIN is entered the betting system synchronizes the contacts from the device (514). The new user is then provided an orientation to the betting system application (516). The user, in an embodiment, can also connect the betting system to local contact stored on their devices. In addition to being able to add individual contacts by entering an email, name or phone number, if the user approves, the device's local contacts can be synced to the betting system and will appear in the user's contact list in the betting system. The betting system will then show the user which of the synced contacts has an existing account with the betting system. If a contact in the user's contact list does not have an existing account with the betting system, the user can invite the contact by sending an invitation by text message, email or other method. The contact will then receive a link to download the betting system app through the Internet from an application marketplace or from a direct link to the betting systems servers. In both described cases of contact list syncing the user can manually decide which contacts to sync and which to exclude.

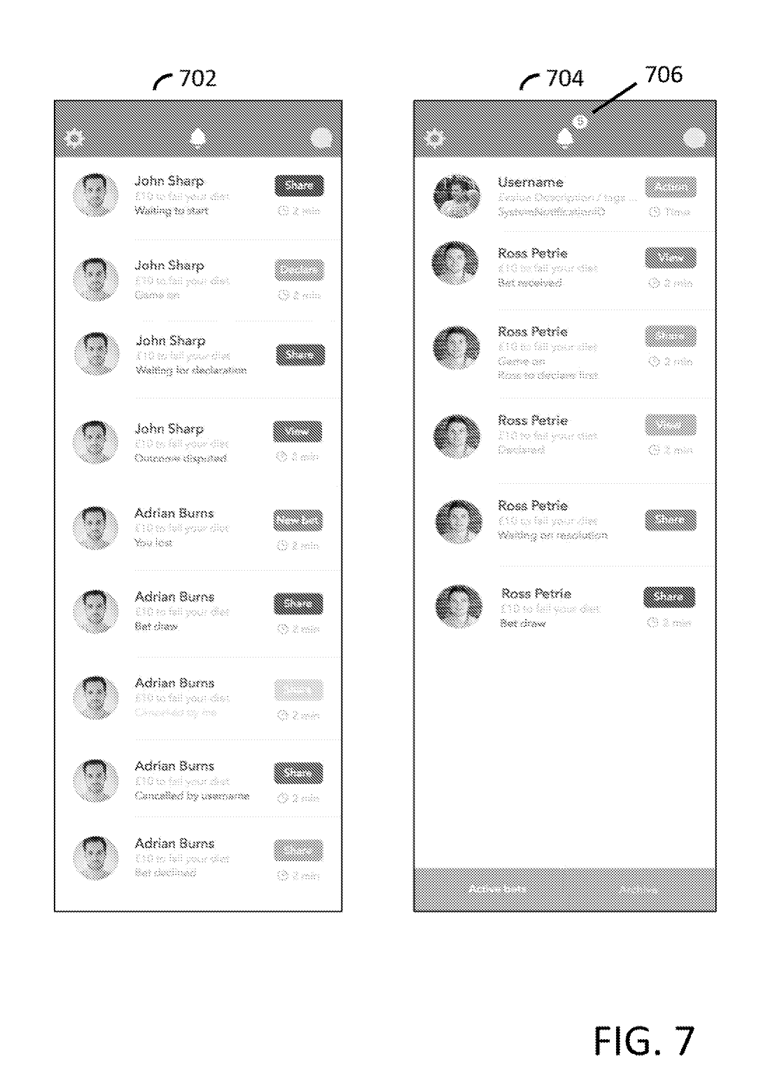

FIGS. 7 through 23 are mobile device screenshots of a self-arbitrating betting system UI according to an embodiment.

FIG. 7 shows the user notifications list on a mobile device according to an embodiment. The user notifications screen appears for both PARSs and INTs. 702 is a user notifications list showing active bets in order of most recent at the top. Active bets are bets in which a cutoff date has passed but no one has declared results or an outcome. 704 is a user notification list showing archived bets. Archived bets are bets that have been declared, resulted in a draw, or are bet offer that have not been accepted. The notifications list icon 706 uses a badge to identify how many pending notifications a user has. In this example the user has five pending notifications. In an embodiment, a push service pushes notifications from the notification list to users, whether or not they are currently viewing the application UI.

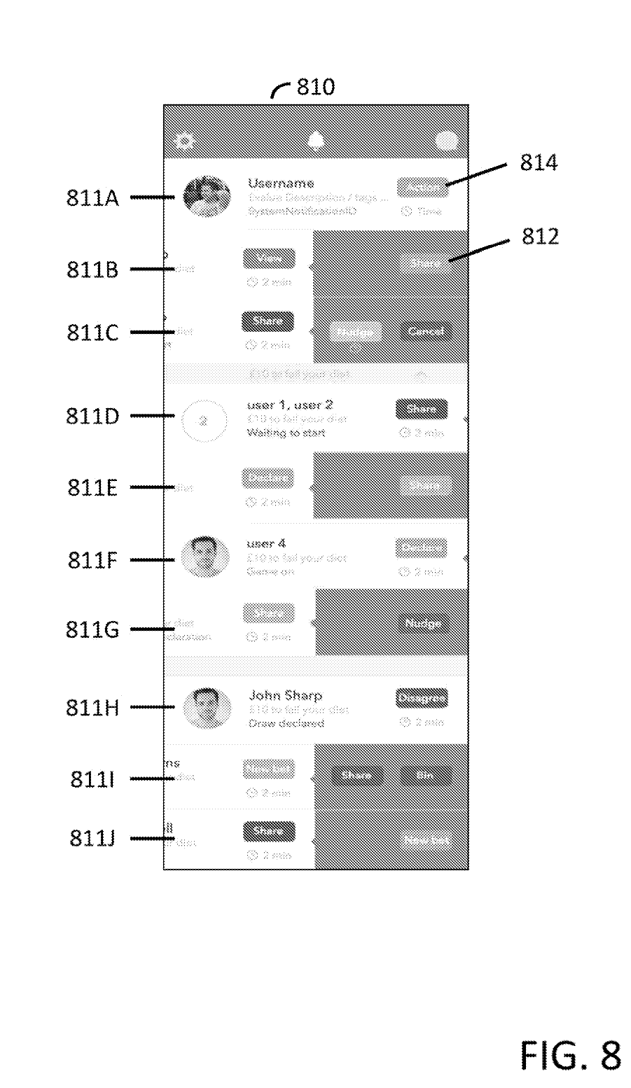

FIG. 8 shows another aspect 800 of a user notifications list according to an embodiment. User notifications list 800 displays primary and secondary actions that can be accessed by the user. From the notifications list 800, the user can access primary actions (e.g, 804) and secondary actions (e.g., 802) by tapping or sliding a notification item 801 to the left or right. In an embodiment, these actions include sharing a bet during any part of the bet cycle, declaring a bet, retracting a bet declaration, nudging a user or disputing a bet declaration. For example, the user can share a bet during any part of the bet cycle by choosing secondary share action 802.

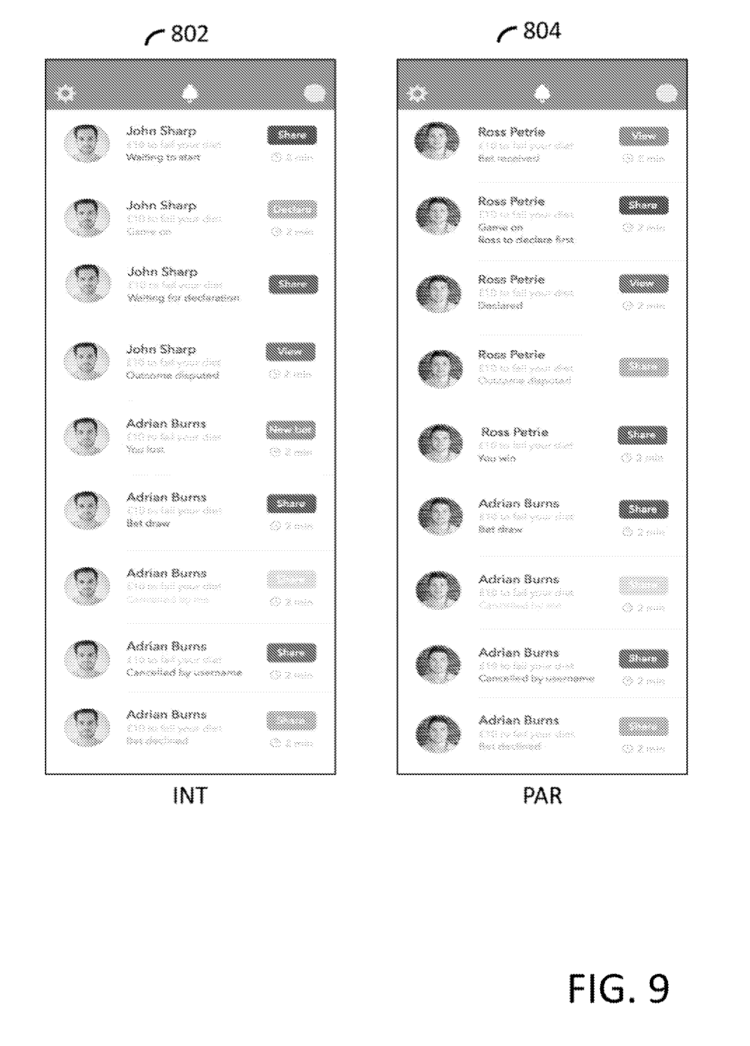

FIG. 9 shows user notifications (802), of an INT and a user notifications list (804) of the PAR according to an embodiment. The INT user notifications list 802 allows the INT to share the outcome of a bet, declare the outcome of bet, share an active bet, and view the details of a bet. The INT can share various aspects of the bet cycle to a linked social network or to a betting system feed. The betting system feed is a continually updated display of all users' shared betting activity, and appears within the betting system app. The PAR user notifications list 804 allows the user to view the outcome of a declared bet, share the outcome of a completed bet, share the outcome of a cancelled bet and view the outcome details of a declared bet. The PAR can contest the outcome of a declared bet when viewing the bet declaration details.

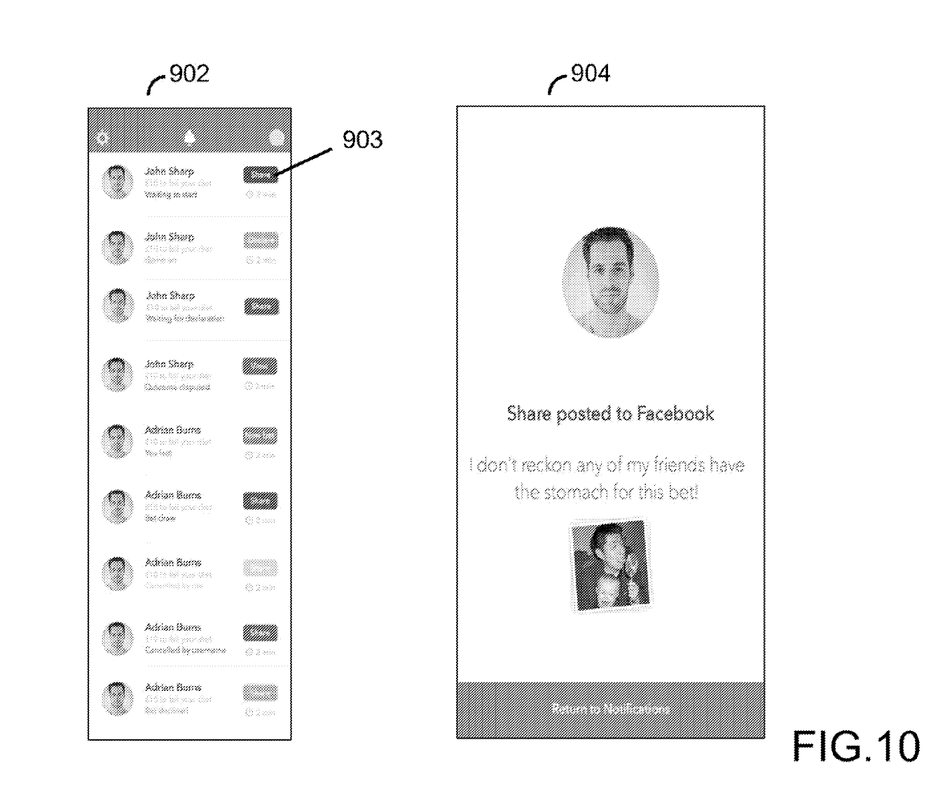

FIG. 10 shows a mobile device screenshot of a user notifications screen 902 and social media sharing screen according to an embodiment. From the INT notifications screen 902, the INT can choose “share” action 903 to share the bet with friends on a social network (or the betting system feed). When sharing the bet, the INT can include one or more photos, comments, videos, emojis, and so on. A social media sharing confirmation screen 904 displayed to the user indicates that their opinion has been shared (in this case on Facebook).

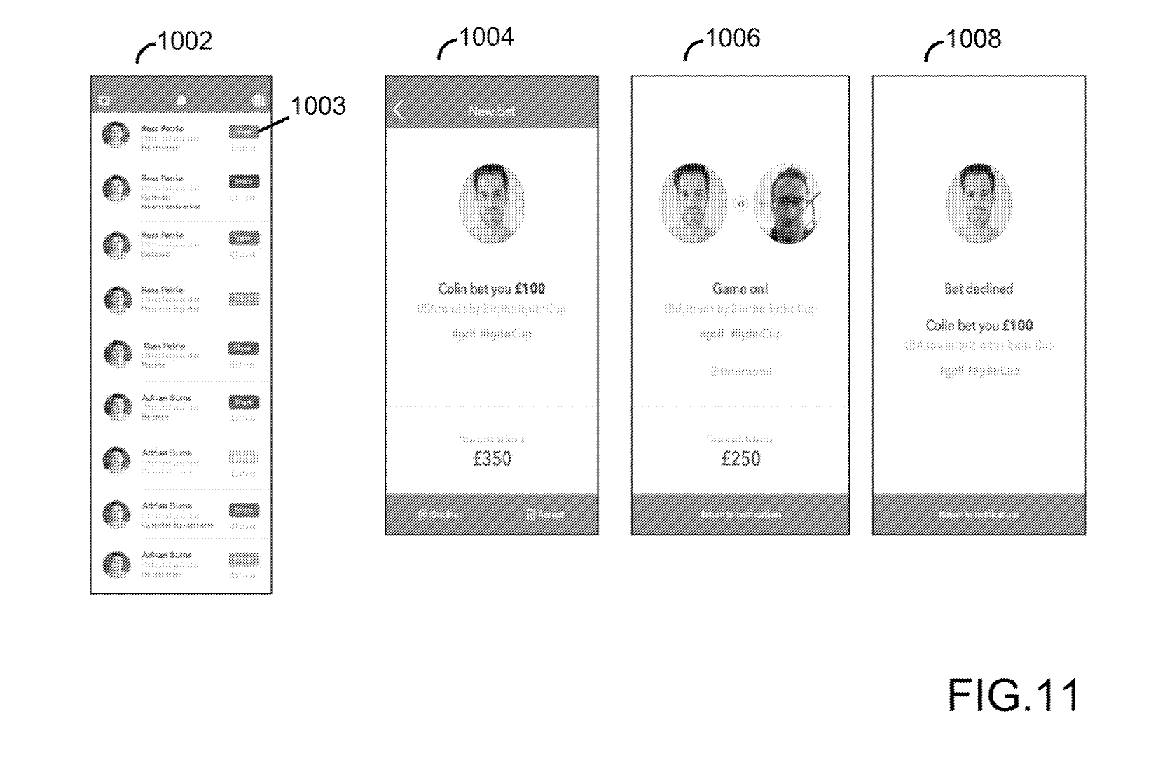

FIG. 11 shows a mobile device series of screenshots displayed to a PAR in a bet acceptance scenario. 1002 is a PAR notification list with the topmost notification item 1003 in a ready-to-view state. A PAR can review a bet offer by selecting the view 1003 bet option in the user notification list 1002. The details of the bet offer are provided including the amount of money or credits to be bet, what the bet topic is, any social networking hashtags associated with the bet, and the user's money or credit balance (as shown in 1004). 1004 shows a screen displayed to the PAR after they select the “view” 1003, 1006 shows a screen displayed to the PAR after acceptance of a bet offer. The user while reviewing the details of the bet offer can decide to either decline or accept the bet 1004. When the PAR accepts the bet offer the details of the bet accepted are shown. Displayed in the details arc the users new cash balance after the amount wagered is taken out 1006. The option for the user to return to the user notification list is available at the bottom of the screen 1006. If the PAR denies the bet offer the INT receives a notification 1008 of the declined bet offer.

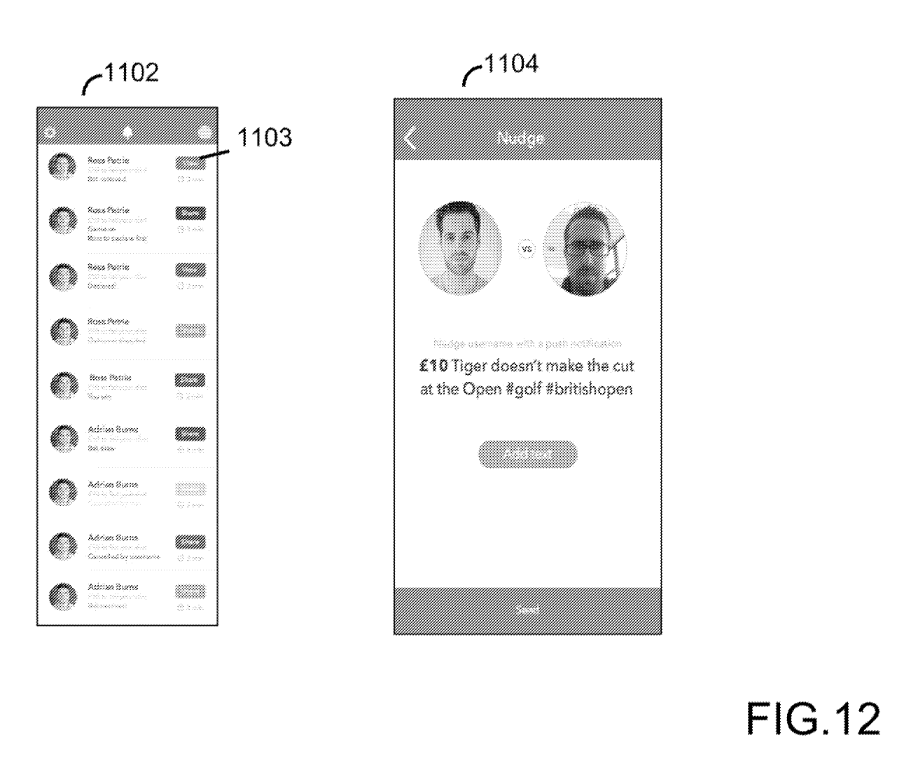

FIG. 12 shows a mobile device screenshot 1102 of the user notifications list according to an embodiment. The user from the notification list 1102 can select to share (by clicking share button 1103) an opinion regarding a bet to a social network, to other online contacts or to the betting system feed.

The user can also remind or “nudge” an INT to declare the outcome of a bet via social networking. Screenshot 1104 is what the user sees when they have chosen to send a nudge. When the user presses “send”, the nudge is sent to the username indicated. Furthermore, the user can send a personal message (using the betting systems push notification service, email and/or SMS) to an INT to remind or “nudge” a user to declare a bet with an outstanding bet declaration. Another option is to set a “countdown nudge”. A “countdown nudge” sets a time period within which a user must take an action; otherwise the bet will end in a draw. Up until the end of the time period, the betting system may send additional notifications at predetermined times until the expiration of the period. The bet will only appear as a draw in the bet reputation system for the user who did not respond in the time set. This negatively affects that user's reputation measure.

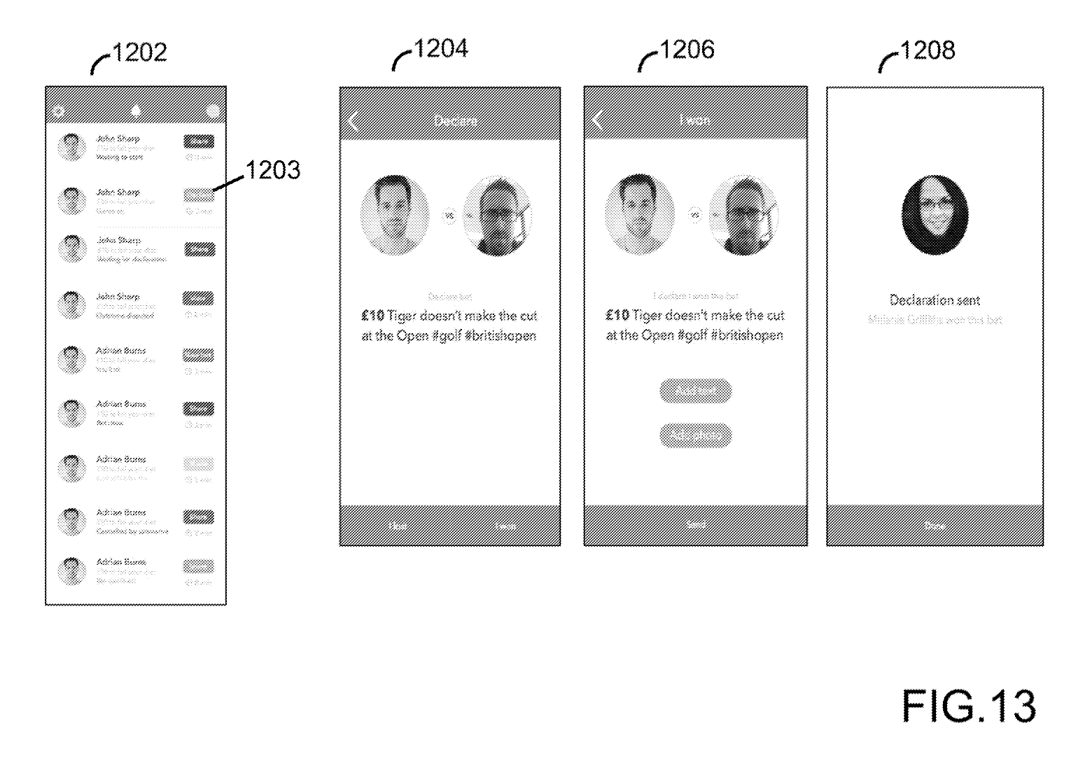

FIG. 13 shows a series of screenshots illustrating an INT bet declaration. The INT user notifications list 1202 allows the user to share the outcome of a bet, declare the outcome of bet (1203), share an active bet, and view the details of a bet. Once the INT selects to declare a pending bet the INT is presented with details of the bet and the option to declare “I lost” or “I won” (as shown in screen 1204. If the INT selects “I won” they are presented with the option to review the declaration and add text, photo or a video as proof of the outcome (as shown in screen 1206). If the INT sends the declaration they will be presented with a confirmation that the declaration has been sent (as shown in screen 1208).

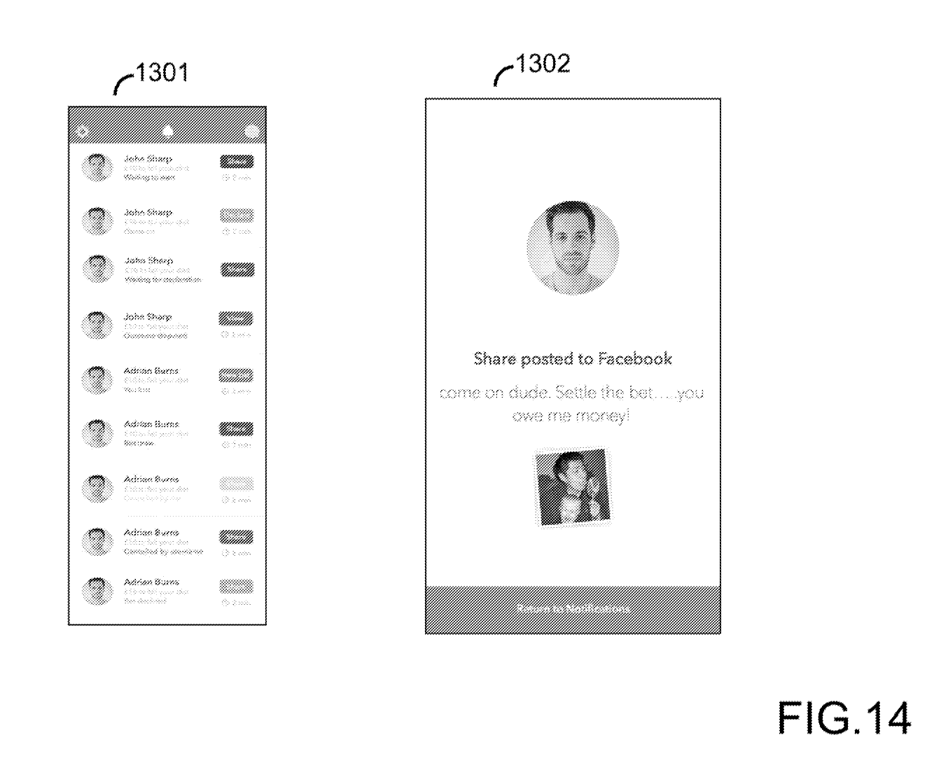

FIG. 14 shows a mobile device screenshot of a user notifications list 1301 and a screenshot 1302 of the social networking share confirmation according to an embodiment. The PAR user notifications list allows the user to share (1303) the outcome of a bet, remind another user to declare the outcome of bet, share an active bet, and view the details of a bet. The PAR can select share 1303 to remind or “nudge” an INT to declare the outcome of the bet using social media. In this case, a confirmation screen of the reminder or “nudge” is shown (e.g., 1302 showing Facebook as an example). The confirmation screen 1302 states what social network the share was posted to, what the text of the share was, and any included photos or videos.

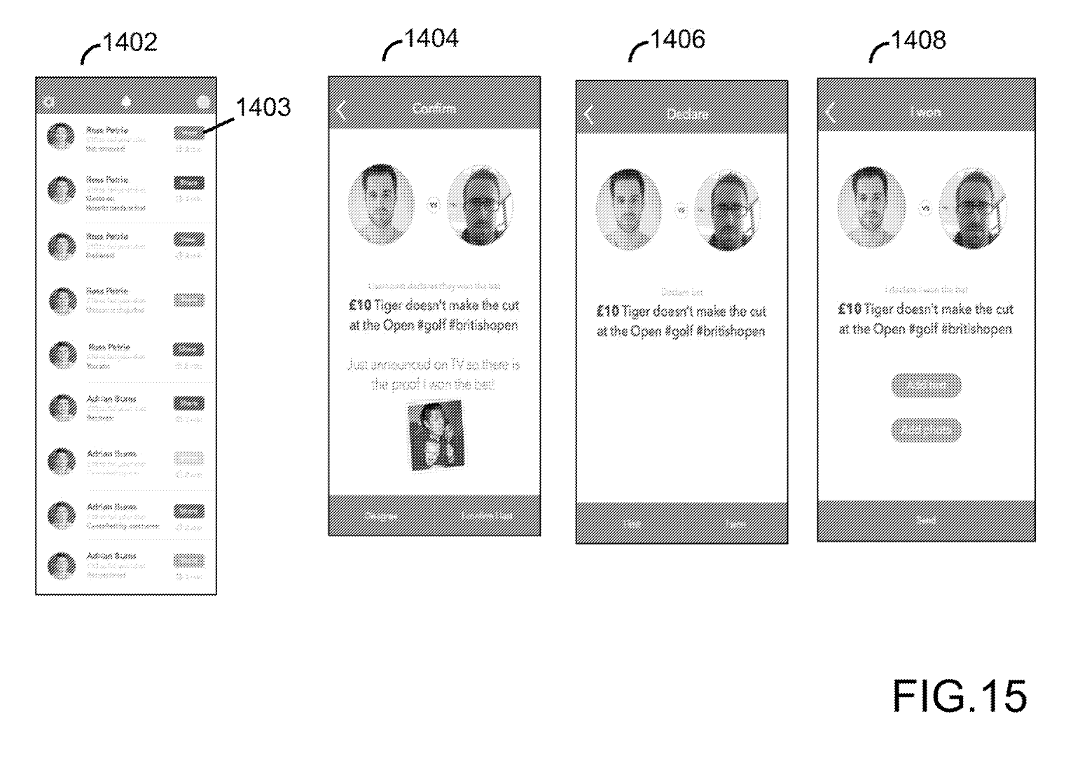

FIG. 15 shows a series of screenshots illustrating what a PAR sees when a bet has been declared by the INT. As further described, the PAR has the opportunity to review the declaration and agree or disagree with the declared outcome. When the INT declares a bet outcome the PAR receives a notification to accept the declared outcome or disagree with it. 1402 is a notifications list displayed to the PAR. The notifications list 1402 shows notification items with pending actions. To view a declared bet, the PAR can select the view option 1403.

1404 shows a confirmation screen displayed when the PAR selects the view option 1403. Screen 1404 states that the bet has been declared and includes any text, photos or videos the INT has provided with the bet declaration as proof of an outcome. The notification that a bet declaration is completed includes an option for the PAR to accept or disagree with the declared outcome of the bet. If the PAR disagrees with the INT bet declaration PAR has the option to provide an alternate declaration. 1406 is a screen displayed to the PAR when they choose to provide an alternate declaration. In the process of proving the alternative bet declaration, the PAR is encouraged (on screen 1408) to add text, photo or video proof of the incorrectness of the bet outcome declared by the INT.

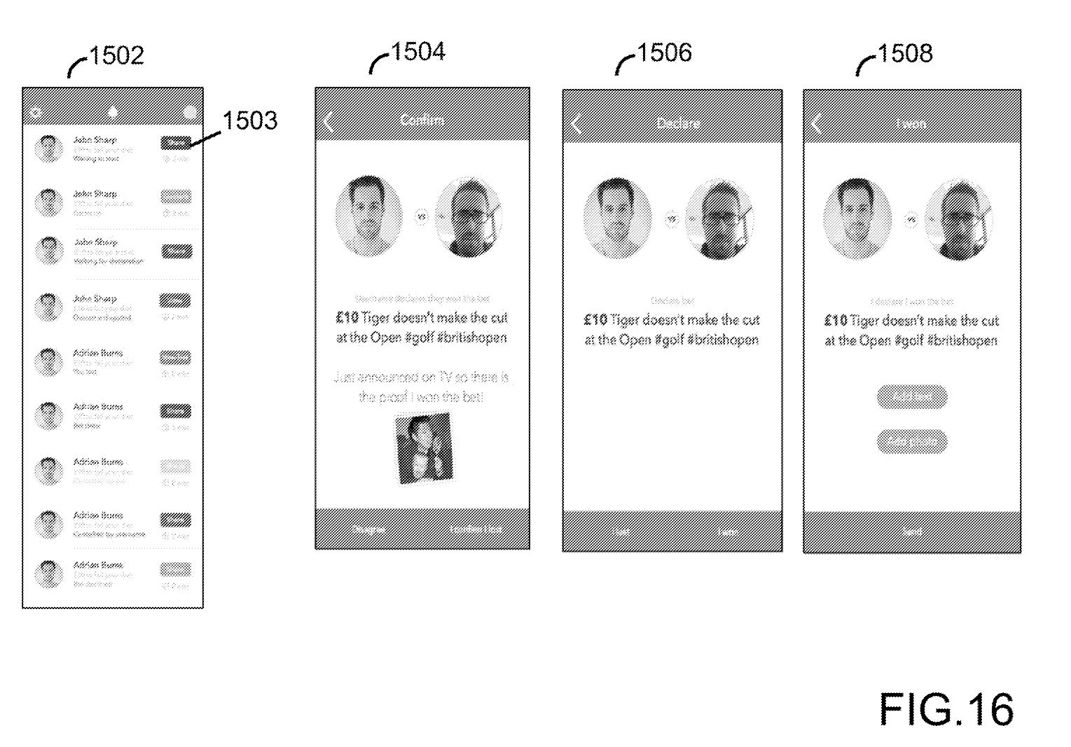

FIG. 16 shows a series of screenshots illustrating what a INT sees when a bet has been disputed by a PAR. As further described, the INT has the opportunity to review the alternative bet declaration made by the PAR (as in FIG. 15), and agree or disagree. When the PAR declares an alternative bet outcome, the INT receives a notification to accept the alternative declared outcome or disagree with it. 1502 is a notifications list displayed to the INT. The notifications list 1502 shows notification items with pending actions. To view the alternative bet declaration, the INT can select the view option 1503.

1504 shows a confirmation screen displayed when the INT selects the view option 1503. Screen 1504 states that an alternative bet declaration has been made, and includes any text, photos or videos the PAR has provided with the alternative bet declaration as proof of the proposed alternative outcome. The notification that a bet declaration is completed includes an option for the INT to accept or disagree with the alternative declared outcome of the bet. If the INT disagrees with the PAR alternative bet declaration, the INT has the option to disagree. 1506 is a screen displayed to the INT when they choose to disagree with the alternative bet declaration. In the process of supporting the disagreement, the INT is encouraged (on screen 1508) to add text, photo or video proof of the incorrectness of the alternative bet outcome declared by the PAR.

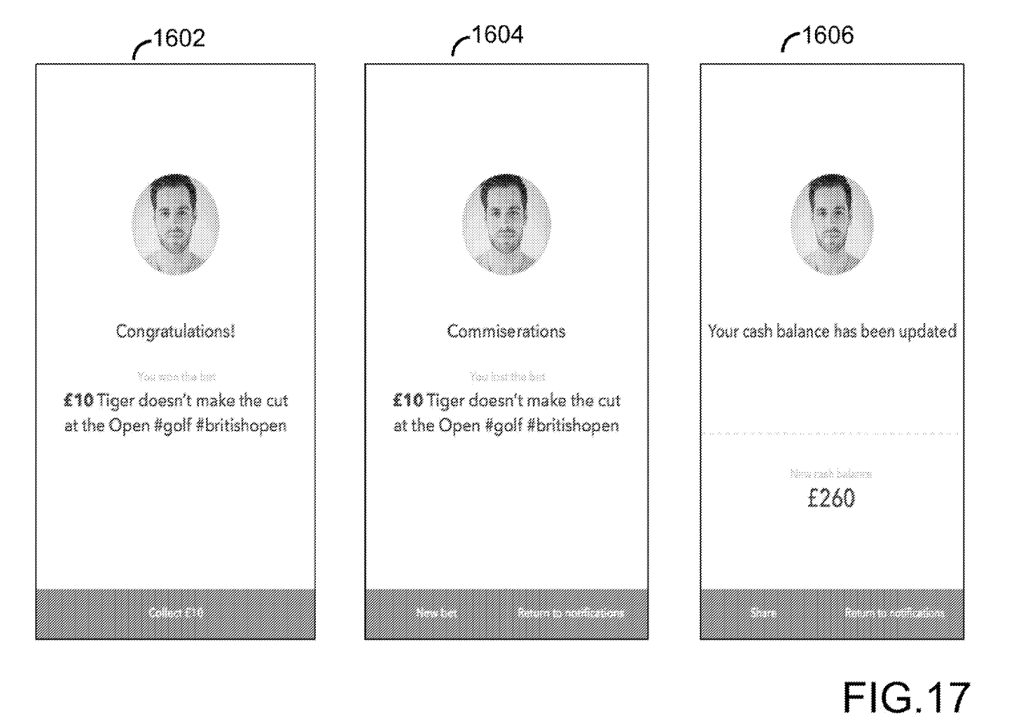

FIG. 17 shows mobile device screenshots of bet outcome notifications for an INT according to an embodiment. 1602 is a screen shot showing what an INT sees when they win a bet. When a bet is declared in the INT's favor, INT receives a notification stating that they won and giving them the option to collect their winnings. 1604 shows a “draw” bet outcome. If a bet ends in a draw, a betting system user receives a notification stating that the outcome is a draw and showing the user's cash balance after the draw. The INT is also given the option to share the bet outcome or return to their notifications screen. If an INT accepts the bet outcome, the INT receives a notification (as shown at 1606) informing them that they lost this bet. The INT is given the option to create as new bet or return to their notifications list.

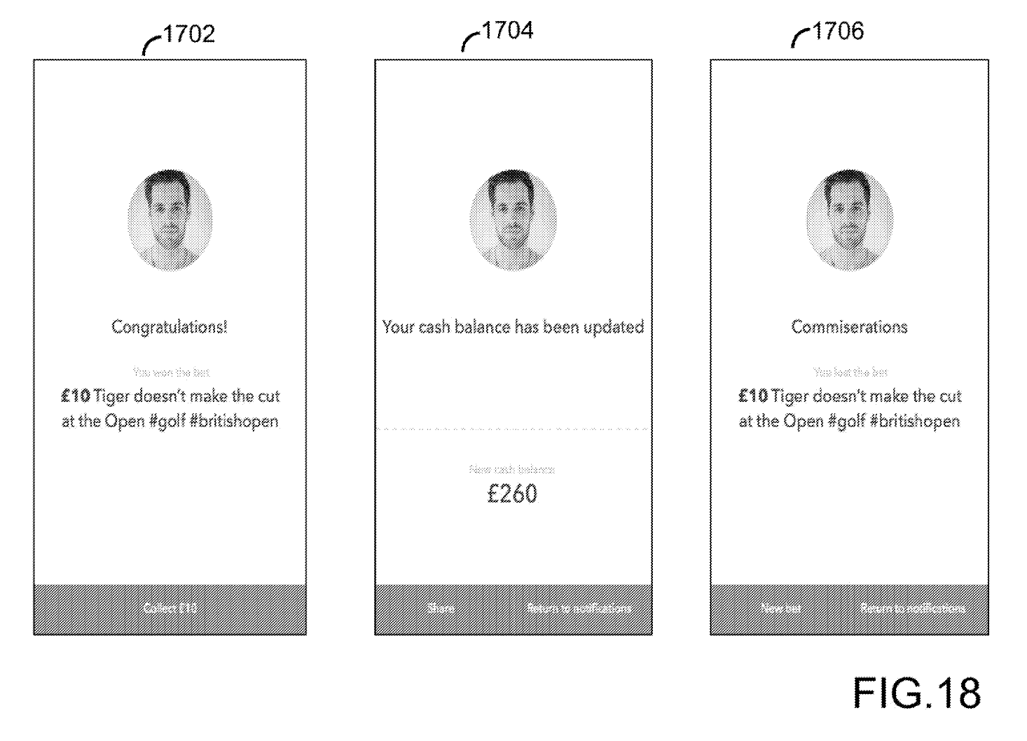

FIG. 18 shows mobile device screenshots of bet outcome notifications for a PAR according to an embodiment. 1702 is a screen shot showing what a PAR sees when they win a bet. A notifications list is shown at 1701. When a bet is declared in the PAR's favor, PAR receives a notification stating that they won and giving them the option to collect their winnings. 1704 shows a “draw” bet outcome. If a bet ends in a draw, a betting system user receives a notification stating that the outcome is a draw and showing the user's cash balance after the draw. The PAR is also given the option to share the bet outcome or return to their notifications screen. If a PAR accepts the bet outcome, the PAR receives a notification (as shown at 1706) informing them that they lost this bet. The PAR is given the option to create a new bet or return to their notifications list.

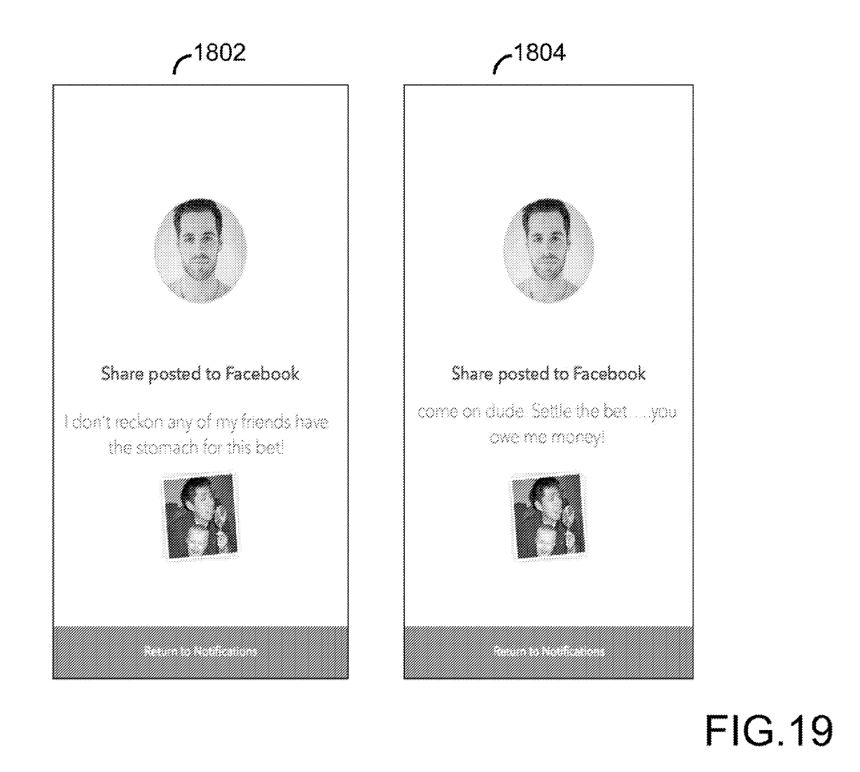

FIG. 19 shows mobile device screenshots of a user sharing bet information to social media according to an embodiment. Throughout the life cycle of a bet, users of the betting system have the option to share details of the bet to social media. 1802 and 1804 are screenshots illustrating examples of user sharing. 1802 is an example of a user sharing a bet via social media and enticing a PAR to accept the bet by taunting or propagating the bet offer. In another example (1804), a PAR can taunt or propagate the undeclared status of a be to social media with the hope of pressuring an INT to declare a bet outcome

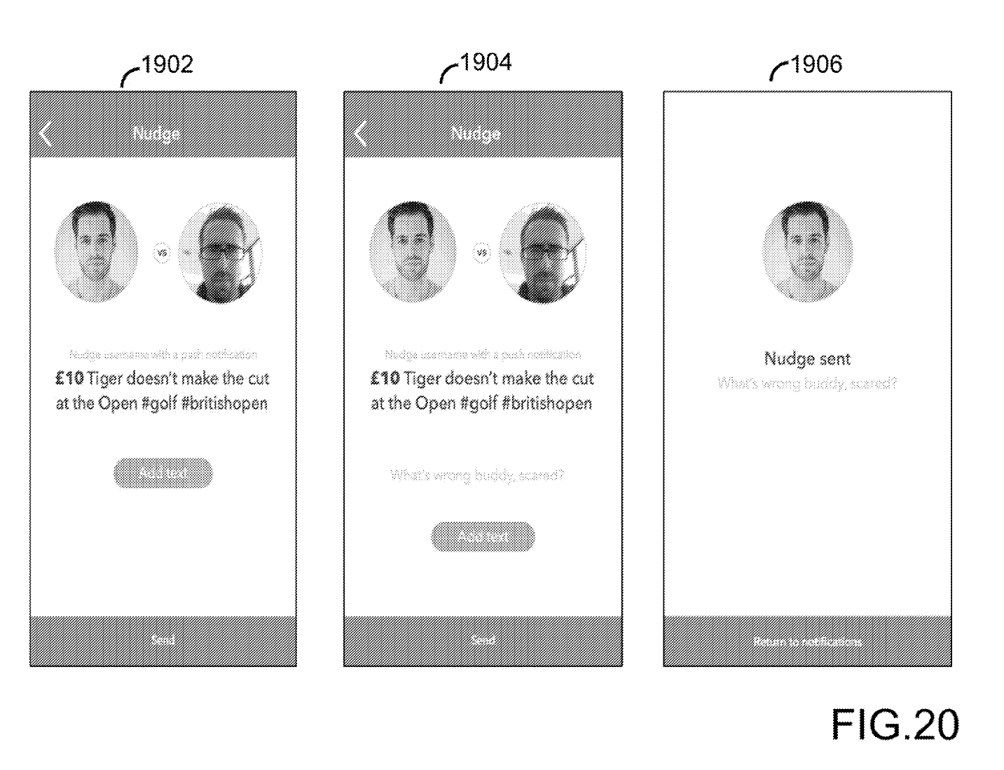

FIG. 20 shows mobile device screenshots of a user engaging the nudge feature according to an embodiment. The nudge feature allows a user to apply pressure on another user to take an action in the betting system. The nudge feature allows a user to send a personal message with customized text to another user using the betting systems push notification service. The nudge feature is available throughout the life cycle of a bet. When a user selects to nudge another user they select a bet as the topic of the nudge and then are prompted with the option to add custom text (as shown in screen shot 1902). When the user adds text, a preview of the nudge with the text included appears. After previewing, the user can select to send the nudge (as shown in screen shot 1904). When a nudge is sent the user receives a confirmation and has the option to return to their notifications list by selecting the option at the bottom of their device screen (as shown in screen shot 1906).

The self-arbitrating betting system includes a bet reputation system for reporting, and tracking user reputation. This system enables users to encourage completion of bets, and to discourage disagreements of declared outcomes. The bet reputation system is designed to apply community pressure to users and is represented visually, for example by stars in the user interface according to an embodiment. The reputation system is displayed in a bet friend's UI during the bet creation process and creates a quick visual indication of how likely a potential INT or PAR will be to complete a bet, or to disagree with the declared outcome of a bet (leading to a draw). The reputation system helps other users to know which users have had favorable interactions with the betting system community.

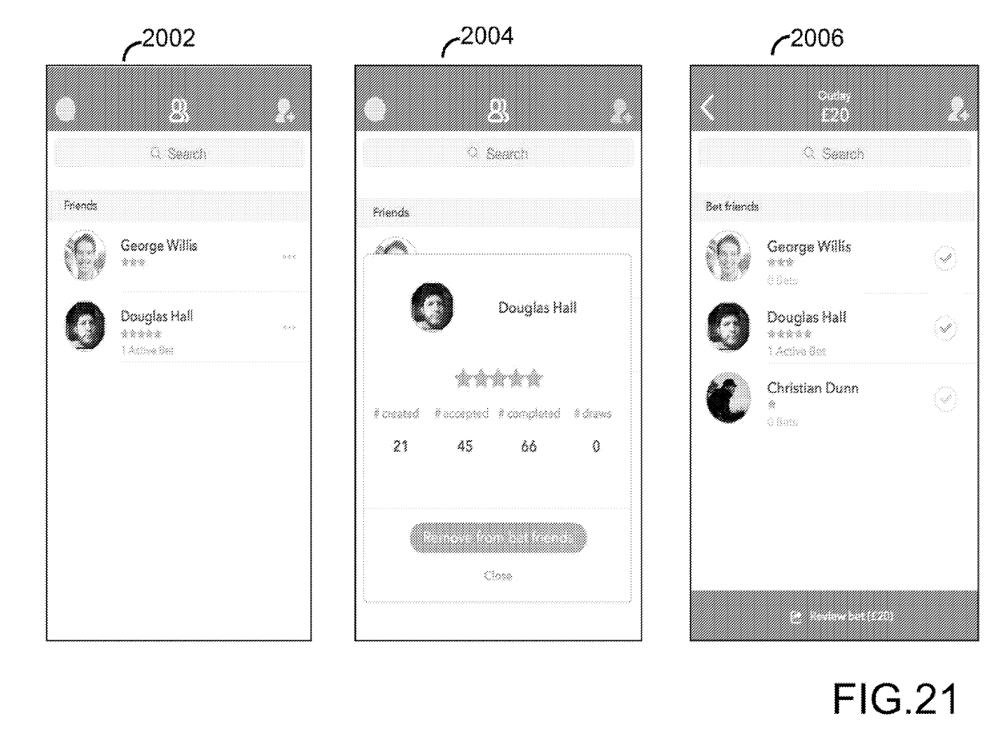

FIG. 21 shows mobile device screen shots of the use of the bet reputation system and bet friend's user interface according to an embodiment. Screen 2002 is a bet friend's user interface that displays friends' names with their reputation rating below their name. In an embodiment, the rating is indicated by the number of stars shown below the name. If a user wants more information on the reputation rating of a friend they can select the friend details and be shown how many bets the user has created, accepted, completed and how many have resulted in draws (screen 2004). The user can also remove a friend from the bet friend's list UI by selecting the option in the details popup (screen 2004). From the bet friend's UI (referring to 2006) an INT can select which friends or PARs to send bet offers to.

A “groupbet” feature of the betting system supports INTs who want to offer bets to multiple friends simultaneously. The bets offered by INT can either be a group bet or multiple one-on-one bets. For multiple one-on-one bets, the multiple bets between the INT and the bet PARs who accept the bet are generated automatically. This allows the INT to have multiple bets operating at the same time, between different PARs, but with the same bet topic at concern. During this process the betting system will be running multiple bets at the same time and they can all be at different stages of the bet life cycle. In one embodiment, the bets are displayed in the INT betting system using an accordion style presentation with a parent/child tree in the notifications list. As with other bets generated, the INT can set a time by which the bet offer expires. The bet time expiration is useful if the bet topic is a sporting event that starts at a specific time and the INT would like to prevent any PARs from accepting the bet offer after the sporting event has already started. If the INT generates a “groupbet” offer to five PARs then the funds are taken out of the INTs account for all the bets at that point in time. If only three of the five PARs accept the bet within the predetermined time, then the remaining funds for the two bets declined are returned to the INT's balance. As in a one-on-one bet, the “groupbet” feature allows a user to set a pre-determined time by which a bet declaration can be made. A user can use this feature to keep an INT or PARs from declaring a bet before the outcome of the bet can be certain. If for instance a soccer match is the bet topic and it is due to end at 4:00 PM in the afternoon on a Saturday, the INT can set the bet so the bet declaration cannot be made until 4:00 PM in the afternoon on a Saturday.

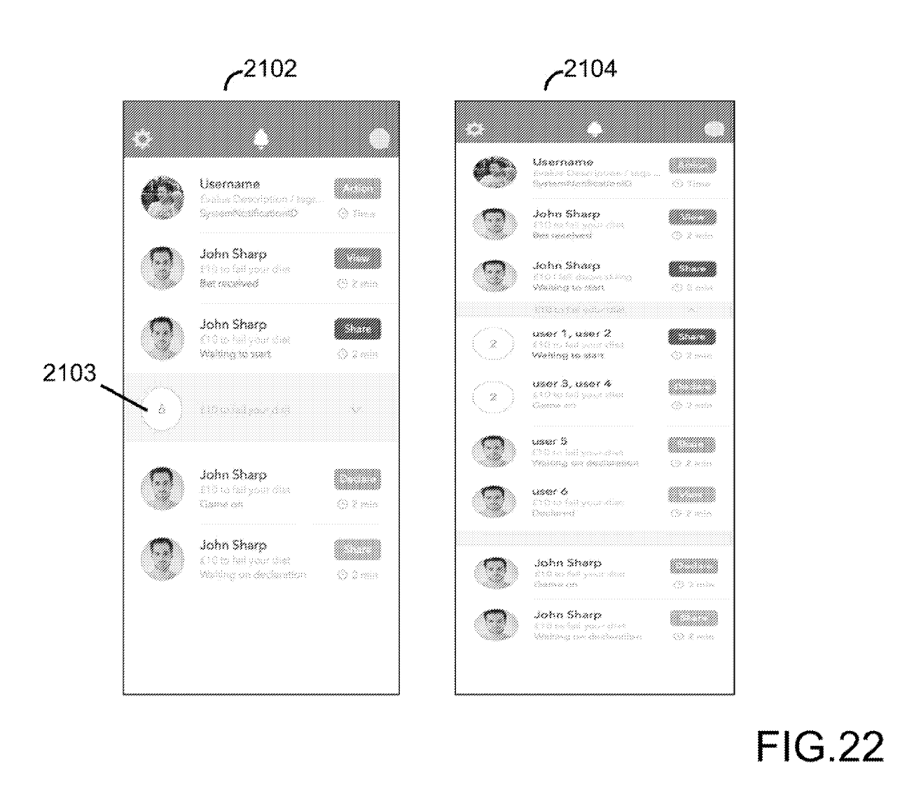

FIG. 22 shows mobile device screen shots of a user's notifications list when the “groupbet” feature is used according to an embodiment. When an INT generates a bet intended for multiple PARs the bet will appear in the notifications list 2102 as a single bet. The number of PARs in the group to which the bet has been offered appears as a notification item 2103. When the INT wants to view the individual bets within the group bet, the INT can select the group bet notification item in the notifications list, and it will expand showing the individual PARS who were sent the bet offer and the status of the offer (accepted, declined, pending), as shown in screen 2104. The “groupbet” feature further allows the INT to communicate and declare a bet outcome to multiple PARs when the multiple PARs are in the same part of the bet cycle.

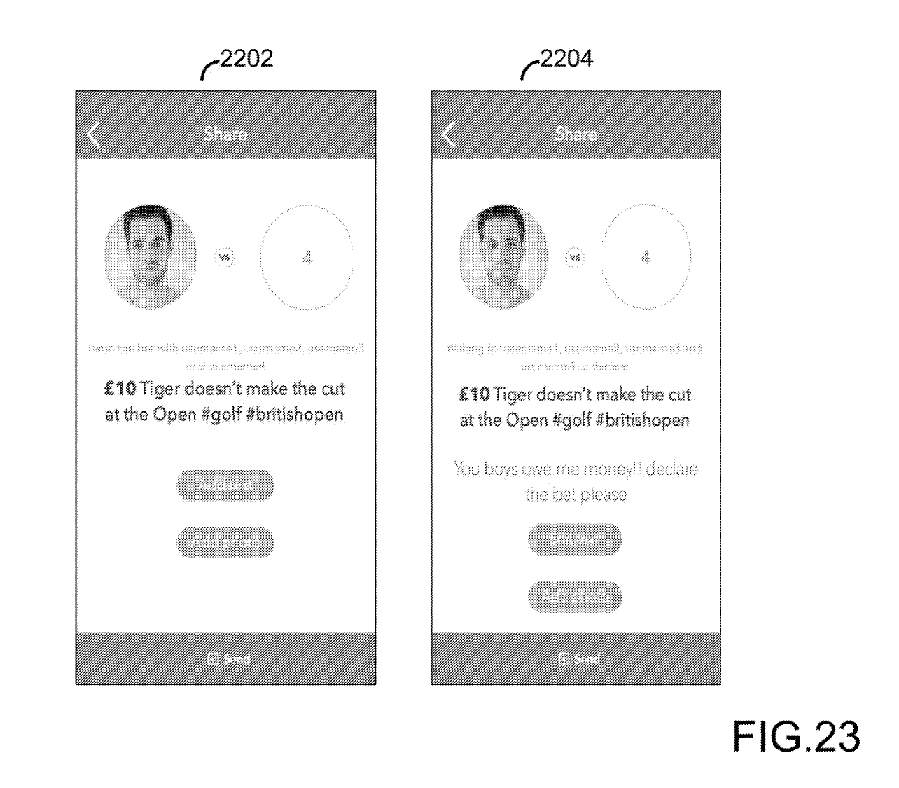

FIG. 23 shows mobile device screen shots of group bet communications and declarations according to an embodiment. For example, if the INT generates a bet offer to multiple PARs using the “groupbet” feature and three (3) PARs out of the eight (8) accept the bet, the INT can send a bet declaration to the three (3) PARs (bet acceptors) who are waiting for a bet outcome to be decided (as shown in screen 2202). The remaining five (5) PARs who have not declared the bet offer can be pressured or taunted into declaring the bet using a single communication by INT using the “nudgebet” feature (as shown in screen 2204).

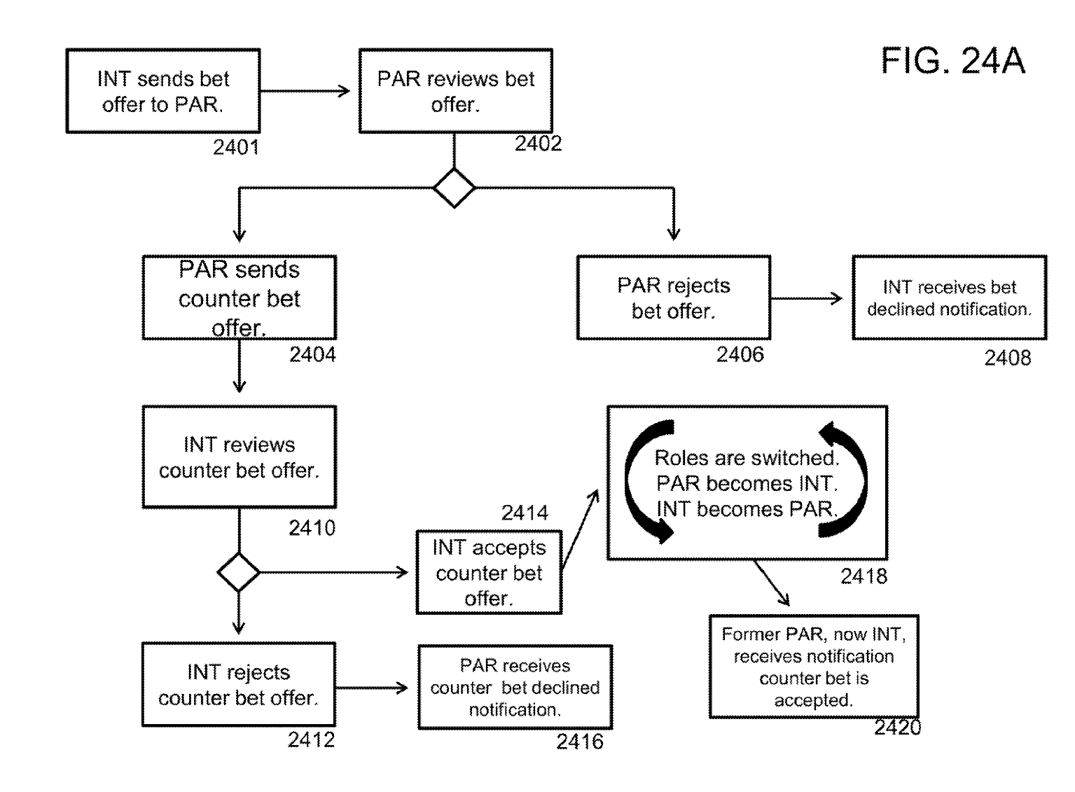

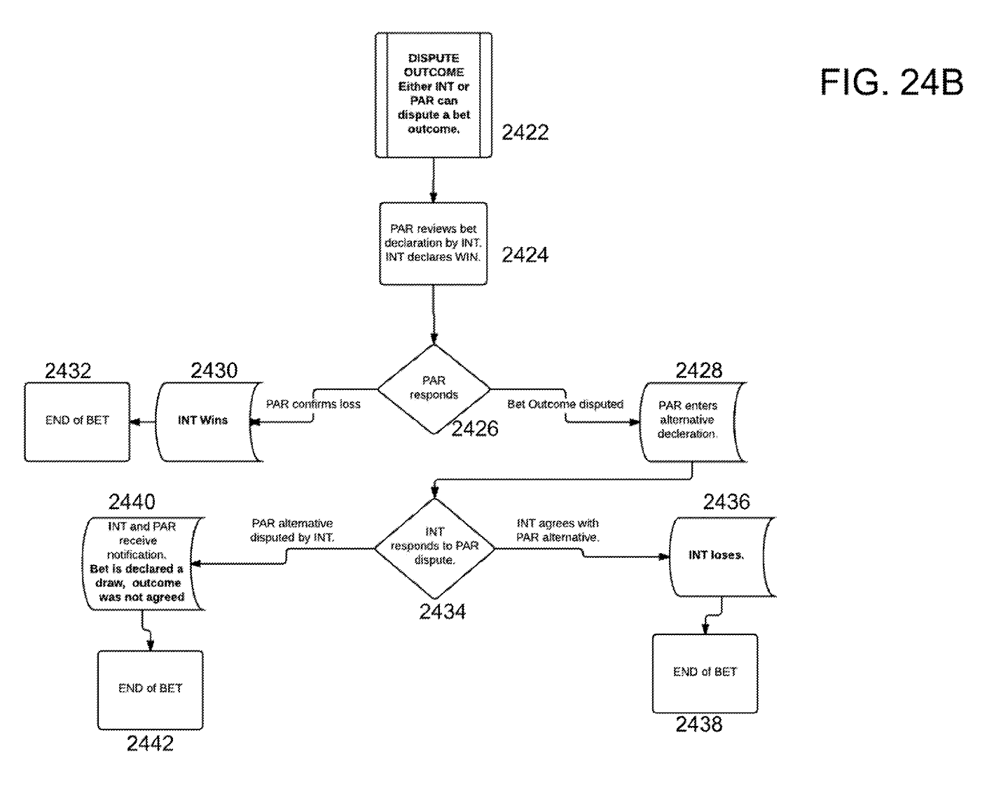

FIG. 24A is a flow diagram of a counter be feature of the betting system according to an embodiment. When INT sends PAR a bet offer (2401) PAR has two options (2402). The first option is to decline the bet (2406). After which the INT will receive a declined bet notification (2408). The second option for PAR is to send a counter bet offer to the INT (2404). The INT has two options after reviewing the counter bet offer (2410). The first option is to decline the counter bet (2412). After which the PAR will receive a counter bet declined notification (2416). The second option is to accept the counter bet offer (2414). Once the counter bet is accepted the roles of the PAR and INT are switched (2418). The former PAR is now the new INT. The former INT is now the new PAR. The new INT then receives a notification that the counter be was accepted (2420).

FIG. 24B is a flow diagram of a disputed bet process according to an embodiment. At 2422, either the INT or a PAR can dispute a bet outcome. In this example, a PAR reviews a be declaration made by the INT (2424). In this bet declaration, the INT declares that the INT won and PAR lost. The PAR responds (2426) in one of two ways. The PAR can confirm the INT win (which is the PAR loss) at 2430, and the bet is ended (also referred to as closed) 2432.

The PAR can also respond by disputing the INT bet declaration and entering an alternative bet declaration (2428). The INT is then given the opportunity to respond to the PAR (2434). The INT may agree or disagree with the PAR's alternative bet declaration. If the INT agrees with the PARs alternative bet declaration, the INT loses the bet (2436), and the bet is at an end or closed (2438).

If the INT disputes the PAR's alternative bet declaration, the INT and the PAR receive notifications indicating that the bet outcome is a draw 2440 (no outcome was agreed upon). This is another way of ending or closing the bet 2442.

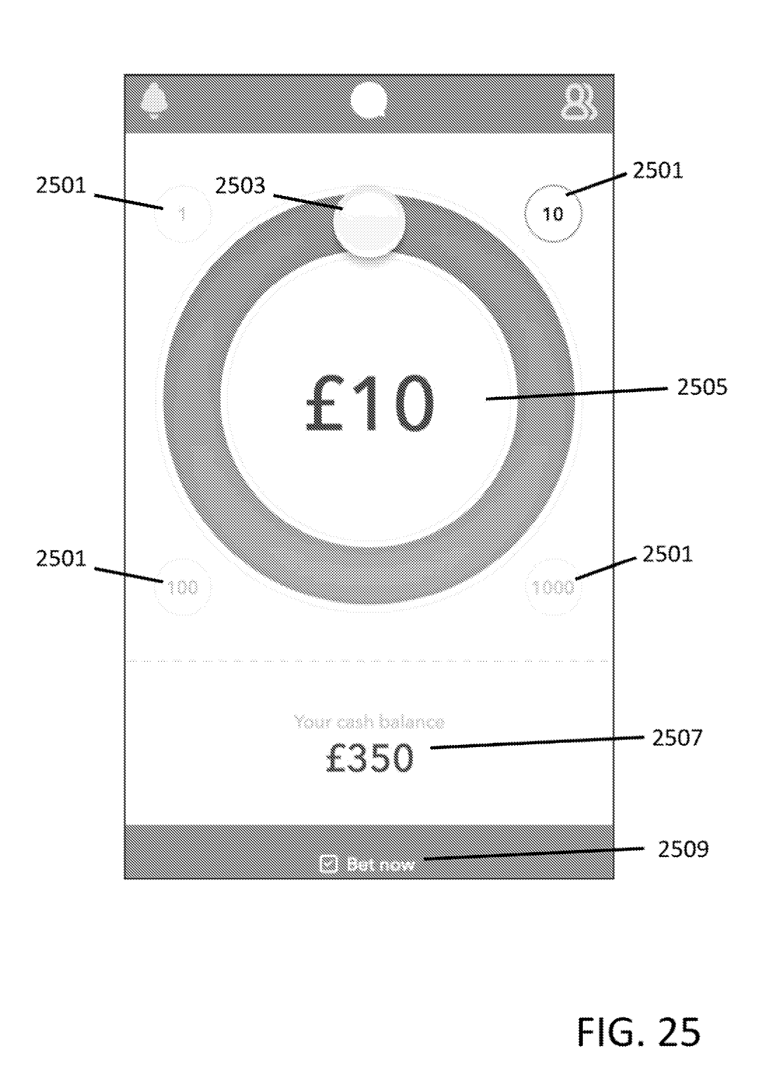

FIG. 25 shows a device screenshot of the betting wheel UI according to an embodiment. The betting wheel is the UI by which an INT of the betting system generates a new bet offer. The betting wheel allows the INT to quickly increase or decrease the bet amount with an easy to use UI. The betting wheel UI has four pre-configured amounts for quick bet generation on the outside corners of the betting wheel (2501). If the INT wants to create a custom bet the user can touch the toggle (2503) and rotate the toggle (250) around the wheel until the desired bet amount is displayed in the center of the wheel (2505). The INT's available account balance is shown below the wheel (2507) and if the user does not have enough funds to generate the bet they are offered the option to add more funds. Once the amount to be bet is decided, as displayed in the center of the wheel (2505), the INT can select “bet now” (2509) at the bottom of the screen.

1. A system for networked social betting, the system comprising:
a plurality of user devices, each capable of communication via the Internet;
a self-arbitrating betting subsystem comprising at least one server configured to execute a self-arbitrating betting method, the method comprising:
onboarding users of the self-arbitrating betting subsystem;
displaying a user interface to the users through the plurality of user devices, through which the users can participate in bets, wherein users comprise bet initiators and bet participants;
wherein a bet initiator:
announces a bet, including subject matter of a bet, conditions of a bet, and stakes of a bet; and
chooses other users to invite as participants to the bet;
tracking the process of the bet from initiation to closure, wherein closure comprises win/loss, and draw; and
facilitating settlement of the bet, comprising causing a transfer of funds between user accounts on behalf of the initiator and participants, wherein the self-arbitrating betting subsystem does not act as a financial institution.

2. The system of claim 1, comprising a plurality of social media networks in communication with the self-arbitrating betting subsystem, wherein the self-arbitrating betting method further comprises facilitating betting notification, wherein bet notification comprises a user notifying social network friends of the existence of a bet, the outcome of a bet, and an opportunity to participate in a bet.

3. The system of claim 1, wherein the self-arbitrating betting method comprises:
receiving a created bet from a bet initiator via the user interface;
receiving bet acceptances from at least one participant via the user interface;
storing the created bet and the bet acceptances as a pending bet; and
receiving a bet result declaration from the bet initiator or a bet participant, wherein a bet result declaration states at least one winner and at least one loser of the bet.

4. The system of claim 3, wherein the self-arbitrating betting method comprises:
displaying on the user interface a user account balance that shows a status of a user account holding betting funds, wherein the betting funds are held by a third party that is not the self-arbitrating betting subsystem; and
wherein the user account balance is updated each time a user takes an action in the bet that commits funds, including accepting a bet.

5. The system of claim 4, wherein:
the user account balance is updated when the bet is closed; and
closure includes win/loss and draw.

6. The system of claim 3, wherein the self-arbitrating betting method comprises:
receiving from the initiator a designation of a time by which the created bet is closed; and
alerting participants in the bet when the bet is closed.

7. The system of claim 3, wherein the self-arbitrating betting method comprises setting a time when the created bet will close if the initiator does not designate a close time.

8. The system of claim 3, wherein the self-arbitrating betting method comprises sending an alert to bet participants when an event occurs, the event chosen from a group comprising:
the bet is closed because a time designated by the initiator has passed;
the bet has closed because the initiator affirmatively closed the bet; and
a winner of the bet has been declared.

9. The system of claim 3, wherein the self-arbitrating betting method comprises:
receiving a dispute of a bet outcome; and
facilitating self-arbitration of the dispute between players, wherein players comprise an initiator and at least one participant.

10. The system of claim 9, wherein the self-arbitrating betting method comprises notifying the players that the bet ended in a draw if the dispute is not successfully arbitrated.

11. The system of claim 10 wherein the self-arbitrating betting method further comprises a method for tracking and displaying a player reputation measure, wherein a player accrues a successively better reputation after being a player in more successive successful bets, wherein a successful bet is at least one bet selected from a list comprising bets that do not end in a draw and bets that are not disputed.

12. The system of claim 11, wherein the self-arbitrating betting method comprises:
maintaining for a user a friends list comprising contact information for friends of the user within the self-arbitrating betting subsystem;
receiving a created bet from an initiator; and
wherein the created bet comprises a hashtag bet, wherein the initiator designates a title for the hashtag bet in the format “#name”.

13. The system of claim 12, wherein the self-arbitrating betting method comprises:
maintaining a list of active hashtag bets organized by hashtag;
receiving a hashtag bet search query from a user who wished to bet on a particular subject matter that might be indicated by the hashtag; and
facilitating the user participating in a hashtag bet whether or not the user was invited to participate in the hashtag bet and whether or not the user and initiator are friends within the self-arbitrating betting subsystem.

14. The system of claim 12, wherein a hashtag bet comprises:
an indication of a maximum number of participants desired by the initiator;
an indication of a minimum reputation measure for participants desired by the initiator; and
a time period within which the hashtag bet is open.

15. The system of claim 11, wherein the self-arbitrating betting method comprises facilitating players sending nudges to each other, wherein a nudge is a reminder to take a pending action in a bet, comprising declaring the outcome of a bet, and taking an action in the bet that is required to prevent the bet ending in a draw.

16. The system of claim 15, wherein facilitating players sending nudges to each other comprises posting a nudge to a social networking site visible to non-players.

17. The system of claim 15, wherein a nudge comprises a countdown nudge that includes a period of time for response, wherein the period of time expires without a response, the bet ends in a draw.

18. The system of claim 15, wherein failing to respond to a nudge before period of time expires, the reputation measure of the non-responding player is negatively affected.

19. A computer-implemented networked self-arbitrating social betting method comprising:
onboarding users of a self-arbitrating betting subsystem, wherein users comprise players, and wherein players comprise bet initiators and bet participants;
displaying a user interface to the users through the plurality of user devices, through which the users can participate in bets,
wherein a bet initiator:
announces a bet, including subject matter of a bet, conditions of a bet, and stakes of a bet; and
chooses other users to invite as participants to the bet;
tracking the process of the bet from initiation to closure, wherein closure comprises win/loss, and draw; and
facilitating settlement of the bet, comprising causing a transfer of funds between user accounts on behalf of the initiator and participants, wherein the self-arbitrating betting subsystem does not act as a financial institution.

20. The method of claim 19, comprising:
the self-arbitrating betting subsystem communicating with a plurality of social media networks; and
the self-arbitrating betting subsystem facilitating bet notification, wherein bet notification comprises a user notifying social network friends of the existence of a bet, the outcome of a bet, and an opportunity to participate in a bet.

21. The method of claim 19, comprising the self-arbitrating betting subsystem:
receiving a created bet from a bet initiator via the user interface;
receiving bet acceptances from at least one participant via the user interface;
storing the created bet and the bet acceptances as a pending bet; and
receiving a bet result declaration from the bet initiator or a bet participant, wherein a bet result declaration states at least one winner and at least one loser of the bet.

22. The method of claim 21, comprising the self-arbitrating betting subsystem displaying on the user interface a user account balance that shows a status of a user account holding betting funds, wherein the betting funds are held by a third party that is not the self-arbitrating betting subsystem, and wherein the user account balance is updated each time a user takes an action in the bet that commits funds, including accepting a bet.

23. The method of claim 22, wherein the user account balance is updated when the bet is closed and closure includes win/loss and draw.

24. The method of claim 21, comprising the self-arbitrating betting subsystem:
receiving from the initiator a designation of a time by which the created bet is closed; and
alerting participants in the bet when the bet is closed.

25. The method of claim 21, comprising the self-arbitrating betting subsystem setting a time when the created bet will close if the initiator does not designate a close time.

26. The method of claim 21, comprising the self-arbitrating betting subsystem sending an alert to bet participants when an event occurs, the event chosen from the group comprising:
the bet is closed because a time designated by the initiator has passed;
the bet has closed because the initiator affirmatively closed the bet; and
a winner of the bet has been declared.

27. The method of claim 21, comprising the self-arbitrating betting subsystem:
receiving a dispute of a bet outcome; and
facilitating self-arbitration of the dispute between players, wherein players comprise at least one initiator and at least one participant.

28. The method of claim 27, comprising the self-arbitrating betting subsystem notifying the players that the bet ended in a draw if the dispute is not successfully arbitrated.

29. The method of claim 28, comprising a method for tracking and displaying a player reputation measure, wherein a player accrues a successively better reputation after being a player in more successive successful bets, wherein a successful bet is at least one bet selected from a list comprising, bets that do not end in a few, and bets that are not disputed.

30. The method of claim 29, comprising the self-arbitrating betting subsystem:
maintaining for a user a friends list comprising contact information for friends of the user within the self-arbitrating betting subsystem; and
receiving a created bet from an initiator, wherein the created bet comprises a hashtag bet, wherein the initiator designates a title for the hashtag bet in the format “#name”.

31. The method of claim 30, comprising the self-arbitrating betting subsystem:
maintaining a list of active hashtag bets organized by hashtag;
receiving a hashtag bet search query from a user who wished to bet on a particular subject matter that might be indicated by the hashtag; and
facilitating the user participating in a hashtag bet whether or not the user was invited to participate in the hashtag bet, and whether or not the user and initiator are friends within the self-arbitrating betting subsystem.

32. The method of claim 30, wherein a hashtag bet comprises:
an indication of a maximum number of participants desired by the initiator;
an indication of a minimum reputation measure for participants desired by the initiator; and
a time period within which the hashtag bet is open.

33. The method of claim 29, comprising the self-arbitrating betting subsystem facilitating players sending nudges to each other, wherein a nudge is a reminder to take a pending action in a bet, comprising declaring the outcome of a bet, and taking an action in the bet that is required to prevent the bet ending in a draw.

34. The method of claim 33, wherein facilitating players sending nudges to each other comprises posting a nudge to a social networking site visible to non-players.

35. The method of claim 33, wherein a nudge comprises a countdown nudge that includes a period of time for response, wherein the period of time expires without a response, the bet ends in a draw.

36. The method of claim 33, wherein failing to respond to a nudge before period of time expires, the reputation measure of the non-responding player is negatively affected.
